(19) United States
(12) Patent Application Publication
(10) Pub. No.: US 2021/0097532 A1
(43) Pub. Date: Apr. 1, 2021

(54) SYSTEMS AND METHODS FOR RECORDING ASSETS AND TRANSACTIONS THEREOF IN BLOCKCHAINS

(71) Applicant: Sak Mahasuverachai, Bangkok (TH)

(72) Inventor: Sak Mahasuverachai, Bangkok (TH)

(21) Appl. No.: 17/048,484

(22) PCT Filed: Apr. 11, 2019
(86) PCT No.: PCT/US19/26988

§ 371 Date: Oct. 16, 2020

Related U.S. Application Data
(60) Provisional application No. 62/660,204, filed on Apr. 19, 2018.

(51) Int. Cl. G06Q 20/38; G06Q 20/40; H04L 9/06; H04L 9/32

(52) U.S. Cl. CPC G06Q 20/389; G06Q 20/401; H04L 2209/38; H04L 9/3247; H04L 9/0643

(57) ABSTRACT

Data corresponding to assets and data corresponding to transactions may be recorded separately on a blockchain such that asset data are stored within asset control compartments and transaction data are stored within transaction compartments. Asset control compartments can themselves form a blockchain such that a blockchain of asset control compartments is embedded within a blockchain of outer blocks. A system may comprise one or more asset control nodes comprising an asset control module for writing asset data to be stored within asset control compartments. A system may comprise one or more transaction nodes each comprising a transaction module for writing transaction data. A system may also comprise one or more standard nodes for adding blocks onto a blockchain, wherein the blocks comprise asset data written by one or more asset control nodes and/or transaction data written by one or more transaction nodes.

### PRIORITY APPLICATION

The present application claims the benefit of U.S. Provisional Patent Application No. 62/660,204, filed on Apr. 19, 2018, entitled Systems and Methods for Recording Assets and Transactions Thereof in Blockchains, the disclosure of which is hereby incorporated by reference herein in its entirety.

### TECHNICAL FIELD

The present disclosure relates generally to systems and methods for recording assets and transactions thereof in a blockchain.

### BACKGROUND

Data handling is a fundamental operation of most businesses. The use of computers for data handling significantly reduces the amount of human errors, saves time and reduces cost within an entity (e.g., business). However, exchanging data between different entities can still be tricky in many aspects due to inherent mistrust between entities. As a result of systems employed to imbue trust in data exchanged between entities, the time and cost of data handling for many businesses is appreciable.

Examples of traditional systems for data exchange include paper-based methods, integration methods, middleman methods, and adapter methods. In paperwork methods, each entity prints relevant data and exchanges physical copies of the digital data, thereby ensuring validity of the data (as manipulation is generally quite easy to spot) while also introducing significant costs associated with printing, signing, and sending the paperwork. In integration methods, each entity maintains its own database that actively searches for and integrates data from all other entities, which becomes expensive and slow once the number of entities involved exceeds a small number. In middleman methods, a 3^{rd} party charges a fee to maintain data of entities, which can be expensive for certain use cases and requires trusting and interfacing with the 3^{rd} party. In adapter methods, a mutually-agreed-upon data handling method for data exchange is employed to update databases, but this requires significant trust in the data handling method by all entities as independent auditing can be difficult or impossible.

Blockchain systems are a relatively new technology that allow transparent, decentralized handling of data. Many blockchain systems exist and are widely used to store and transact assets. Popular blockchain systems include Bitcoin, Litecoin, and Ethereum. These systems use either proof of work or proof of stake to establish validity of blocks of data in a blockchain. Many nodes in the system act to establish proof of work or proof of stake for a newly created block in order to add it to their blockchain. Trust in the system is established by consensus amongst the nodes as to the validity of newly added blocks. Each node independently records the blockchain and can therefore verify the validity of any block on the chain or any block that is purported by a node to be a part of the chain (e.g., can audit the blockchain). However, conventional proof of work and proof of stake systems have disadvantages. Proof of stake systems can be abused if a small number of nodes control a large percentage of the asset used as the stake (e.g., by allowing bad-faith actions by majority stakeholders to be considered valid). Proof of work systems become inefficient as the system matures and more resources are dedicated to establishing proof of work (e.g., many nodes perform redundant work, as is currently the case with Bitcoin).

### SUMMARY

Current blockchain systems are designed to transact a single asset and, moreover, require majority (e.g., unanimous) consensus of the nodes (e.g., stakeholders) of the system before changing the transaction protocol (e.g., changing the type or amount of asset being stored). Therefore, blockchain protocols are rarely modified and individual assets are currently recorded on separate blockchains, which introduces complexity, cost, and risk (e.g., of unapproved data manipulation). There is a need, therefore, for blockchain systems and methods that allow multiple assets to be transacted in a single system. Moreover, there is a continued need for systems and methods of recording data on a blockchain with high degrees of transparency. High degrees of transparency increase trust in a system.

The present disclosure provides, inter alia, systems and methods that store asset data corresponding to a plurality of assets together with transaction data corresponding to one or more transactions of the plurality of assets and, additionally, allow one or more permissioned nodes to write asset data to a blockchain corresponding to the plurality of assets. Thus, in certain embodiments, individual, permissioned nodes, referred to herein as asset control nodes, can control individual assets on a single blockchain, thereby allowing multiple assets to be created, updated, regulated, and deleted by the nodes, while also recording transactions of the assets on the blockchain. This can enable complex transactions to be recorded on a single blockchain. For example, in certain embodiments, transaction data recorded in a block on a blockchain corresponds to a single transaction involving a plurality of assets for which asset data is also recorded on the blockchain.

In certain embodiments, data corresponding to assets and data corresponding to transactions are recorded separately on a blockchain such that asset data corresponding to the assets are stored within asset control compartments and transaction data corresponding to the transaction are stored within transaction compartments. The asset control compartments and transaction compartments are stored within outer blocks on the blockchain, such that each outer block that forms the chain of blocks in the blockchain comprises at least one of an asset control compartment and a transaction compartment. Asset control compartments can themselves form a blockchain (e.g., that uses a proof-of-work protocol to link the compartments together) such that a blockchain of asset control compartments is embedded within a blockchain of outer blocks. This provides an extra layer of security for asset data stored on a blockchain. In certain embodiments, all of the data in an preceding outer block is used to determine a validation string showing proof-of-work for an asset control compartment such that a blockchain of outer blocks and a blockchain of asset control compartments do not have a strict hierarchy. This can provide an additional layer of security to the data stored in the blockchains within a system by, in essence, entwining the asset control compartment blockchain and outer block blockchain.

In certain embodiments, a system comprises a plurality of nodes with varying levels of permission related to data writing and supervision within the system. In certain embodiments, a system comprises one or more asset control nodes comprising an asset control module for writing asset data to be stored within asset control compartments on a blockchain. In this way, in certain embodiments, a particular node within a system is responsible for each asset that is transacted within the system. A system may comprise one or more assessor nodes for permissioning and monitoring activity of a subset (or all) of the asset control nodes within a system. This can provide oversight and limit (or eliminate) bad faith actions by asset control nodes. Assessor node(s) may be permissioned and/or otherwise monitored by a super node. In certain embodiments, a system also comprises one or more transaction nodes each comprising a transaction module for writing transaction data to be stored within transaction compartments on a blockchain. Transaction data may need to be validated (e.g., approved) by one or more transaction nodes and/or an asset control node before being allowed to be added to a transaction compartment. A system may also comprise one or more standard nodes for adding blocks (e.g., asset control compartments or outer blocks) (e.g., by mining) onto a blockchain, wherein the blocks comprise asset data written by one or more asset control nodes in an asset control compartment and/or transaction data written by one or more transaction nodes in a transaction compartment.

The present disclosure additionally encompasses, inter alia, the recognition that the constant mining reward for adding new blocks to conventional blockchains utilizing proof-of-work protocols creates inefficiencies that have harmful societal impacts due to high energy consumption. Each miner is incentivized to maximize their computing power in order to increase their revenue from mining, but only one miner receives a reward for each block mined. This leads to much redundant work being performed that requires high amounts of energy to be consumed. A time-variable mining reward can be used to reduce the amount of redundant work performed and therefore reduce energy consumption of a blockchain system, which has positive benefits for society. In certain embodiments, systems and methods disclosed herein use a mining reward that depends, at least in part, on the last time that a node has mined a block on the blockchain. Time can be measured in absolute terms (e.g., hours or minutes) or relative terms (e.g., a number of blocks since the last block a miner has added to a blockchain). A time-variable mining reward can follow any of a variety of functional relationships, such as, for example, a step-function, an error function, an asymptotic function, or a linear function. A system or method can use an estimated time since a last block was mined by a miner to determine a time-variable mining reward, wherein the estimated time is rounded (e.g., to a nearest minute or nearest hour).

In some aspects, the present disclosure is directed to a method of storing data (e.g., corresponding to assets and transactions with the assets) in a blockchain, the method comprising: receiving, by a processor of a computing device (e.g., node), an asset control compartment comprising (i) asset data [e.g., corresponding to one or more assets (e.g., currency, inventory, or identities)] and, optionally, (ii) an asset control validation string (e.g., based, at least in part, on the asset data in the asset control compartment) and a transaction compartment comprising transaction data [e.g., corresponding to one or more transactions and/or authorizations of access (e.g., of and/or to the one or more assets, respectively)]; creating, by the processor of the computing device, a new outer block comprising the asset control compartment and the transaction compartment; determining, by the processor of the computing device, a hash based, at least in part, on the asset control compartment (e.g., the asset data and, if present, the asset control validation string) and the transaction compartment (e.g., the transaction data); modifying (e.g., writing to), by the processor of the computing device, the new outer block such that the new outer block comprises the hash; and optionally, storing, by the processor of the computing device, the new outer block on a non-transitory computer readable medium (e.g., in the blockchain).

In certain embodiments, the method comprises determining, by the processor of the computing device, the hash based, at least in part, on a digital signature corresponding to the computing device.

In certain embodiments, the method comprises determining, by the processor of the computing device, the hash based, at least in part, on one or more previously mined outer blocks (e.g., one previously mined outer block) [e.g., determining the hash based, at least in part, on a preceding outer block, wherein the preceding outer block immediately precedes the new outer block in an ordered sequence of blocks on the blockchain (e.g., is a most recent block on the blockchain)].

In certain embodiments, the one or more previously mined outer blocks each comprise verification data comprising one or more digital signatures (e.g., received from one or more verifying nodes) such that the hash is determined based, at least in part, on the verification data. In certain embodiments, at least one of the one or more previously mined outer blocks corresponds to a block that does not comprise an asset control compartment (e.g., and does comprise a transaction compartment). In certain embodiments, each of the one or more previously mined outer blocks comprises a previously mined outer block hash that has been determined based, at least in part, on one or more other previously mined outer blocks.

In certain embodiments, the asset control validation string is based, at least in part, on one or more established asset control validation strings corresponding to one or more previously mined asset control compartments, wherein each of the one or more earlier asset control compartments comprises one (e.g., only one) of the one or more established asset control validation strings.

In certain embodiments, the method comprises: receiving, by the processor of the computing device, verification data comprising one or more digital signatures corresponding to one or more nodes that have validated the new outer block; and modifying, by the processor of the computing device, the new outer block to comprise the verification data (e.g., in a header of the new outer block).

In certain embodiments, the transaction data corresponds to one or more transactions that have been approved for recordation on the blockchain (e.g., by at least one transaction node and an asset control node). In certain embodiments, the method comprises: receiving, by the processor of the computing device, the transaction data (e.g., from a list of approved transactions); and creating, by the processor of the computing device, the transaction compartment such that the transaction compartment comprises the transaction data.

In certain embodiments, the transaction data corresponds to at least one of (i) one or more exchanges of at least one asset (e.g., a currency or inventory) and (ii) an authorization to access at least one asset (e.g., an identification) (e.g., wherein the asset is one of the one or more assets corresponding to the asset data). In certain embodiments, (i) at least a portion of the asset data is identification data corresponding to one or more personal identities, (ii) at least a portion of the transaction data corresponds to one or more authorizations to access, records of access, or verifications of identification data, or (iii) both (i) and (ii). In certain embodiments, the asset data corresponds to at least one of creation, update (e.g., modification), regulation, and deletion of one or more assets (e.g., currency, inventory, or identities). In certain embodiments, the asset data has been provided by an asset control node.

In certain embodiments, the method comprises: broadcasting, by the processor of the computing device, over a network to a plurality of computing devices (e.g., a plurality of nodes), the new outer block after the modifying step.

In certain embodiments, the blockchain is a public blockchain.

In some aspects, the present disclosure is directed to a system for storing data (e.g., corresponding to assets and transactions with the assets) in a blockchain, the system comprising: a processor (e.g., wherein a node comprises the processor); and a non-transitory computer readable medium (e.g., memory) having instructions stored thereon, wherein the instructions, when executed by the processor, cause the processor to: receive an asset control compartment comprising (i) asset data [e.g., corresponding to one or more assets (e.g., currency, inventory, or identities)] and, optionally, (ii) an asset control validation string (e.g., based, at least in part, on the asset data in the asset control compartment) and a transaction compartment comprising transaction data [e.g., corresponding to one or more transactions and/or authorizations of access (e.g., of and/or to the one or more assets, respectively)]; create a new outer block comprising the asset control compartment and the transaction compartment; determine a hash based, at least in part, on the asset control compartment (e.g., the asset data and, if present, the asset control validation string) and the transaction compartment (e.g., the transaction data); modify (e.g., write to) the new outer block such that the new outer block comprises the hash; and optionally, store the new outer block on a (e.g., the) non-transitory computer readable medium (e.g., in the blockchain).

In certain embodiments, the instructions, when executed by the processor, cause the processor to: determine the hash based, at least in part, on a digital signature corresponding to the computing device.

In certain embodiments, the instructions, when executed by the processor, cause the processor to: determine the hash based, at least in part, on one or more previously mined outer blocks (e.g., one previously mined outer block) [e.g., determining the hash based, at least in part, on a preceding outer block, wherein the preceding outer block immediately precedes the new outer block in an ordered sequence of blocks on the blockchain (e.g., is a most recent block on the blockchain)]. In certain embodiments, the one or more previously mined outer blocks each comprise verification data comprising one or more digital signatures (e.g., received from one or more verifying nodes) such that the hash is determined based, at least in part, on the verification data. In certain embodiments, at least one of the one or more previously mined outer blocks corresponds to a block that does not comprise an asset control compartment (e.g., and does comprise a transaction compartment). In certain embodiments, each of the one or more previously mined outer blocks comprises a previously mined outer block hash that has been determined based, at least in part, on one or more other previously mined outer blocks.

In certain embodiments, the asset control validation string is based, at least in part, on one or more established asset control validation strings corresponding to one or more previously mined asset control compartments, wherein each of the one or more earlier asset control compartments comprises one (e.g., only one) of the one or more established asset control validation strings.

In certain embodiments, the instructions, when executed by the processor, cause the processor to: receive verification data comprising one or more digital signatures corresponding to one or more nodes that have validated the new outer block (e.g., by validating the hash and/or data on which the hash is based); and modify the new outer block to comprise the verification data (e.g., in a header of the new outer block).

In certain embodiments, the transaction data corresponds to one or more transactions that have been approved for recordation on the blockchain (e.g., by at least one transaction node and an asset control node).

In certain embodiments, the instructions, when executed by the processor, cause the processor to: receive the transaction data (e.g., from a list of approved transactions); and create the transaction compartment such that the transaction compartment comprises the transaction data.

In certain embodiments, the transaction data corresponds to at least one of (i) one or more exchanges of at least one asset (e.g., a currency or inventory) and (ii) an authorization to access at least one asset (e.g., an identification) (e.g., wherein the asset is one of the one or more assets corresponding to the asset data). In certain embodiments, (i) at least a portion of the asset data is identification data corresponding to one or more personal identities, (ii) at least a portion of the transaction data corresponds to one or more authorizations to access, records of access, or verifications of identification data, or (iii) both (i) and (ii). In certain embodiments, the asset data corresponds to at least one of creation, update (e.g., modification), regulation, and deletion of one or more assets (e.g., currency, inventory, or identities). In certain embodiments, the asset data has been provided by an asset control node.

In certain embodiments, the instructions, when executed by the processor, cause the processor to: broadcast, over a network to a plurality of computing devices (e.g., a plurality of nodes), the new outer block after the modifying step.

In certain embodiments, the blockchain is a public blockchain.

In some aspects, the present disclosure is directed to a system for storing multi-asset data in a blockchain, the system comprising: an outer block comprising a hash; an asset control compartment comprising (i) asset data [e.g., corresponding to one or more assets (e.g., currency, inventory, or identities)] and, optionally, (ii) an asset control validation string (e.g., a cryptographic hash satisfying one or more validation conditions) (e.g., based, at least in part, on the asset data in the asset control compartment); and a transaction compartment comprising transaction data [e.g., corresponding to one or more transactions and/or authorizations of access (e.g., of and/or to the one or more assets)], wherein the outer block comprises the asset control compartment and the transaction compartment and the hash is based, at least in part, on the asset control compartment (e.g., the asset data and, if present, the asset control validation string) and the transaction compartment (e.g., the transaction data).

In certain embodiments, the hash is based, at least in part, on one or more previously mined outer blocks [e.g., determining the hash based, at least in part, on a preceding outer block, wherein the preceding outer block immediately precedes the new outer block in an ordered sequence of blocks on the blockchain (e.g., is a most recent block on the blockchain)]. In certain embodiments, the one or more previously mined outer blocks each comprise verification data comprising one or more digital signatures (e.g., received from one or more verifying nodes) such that the hash is determined based, at least in part, on the verification data. In certain embodiments, at least one (e.g., only one) of the one or more previously mined outer blocks corresponds to a block that does not comprise an asset control compartment (e.g., and does comprise a transaction compartment). In certain embodiments, each of the one or more previously mined outer blocks comprises a previously mined outer block hash that has been determined based, at least in part, on one or more other previously mined outer blocks.

In certain embodiments, the asset control validation string is based, at least in part, on one or more established asset control validation strings corresponding to one or more mined asset control compartments, wherein each of the one or more earlier asset control compartments comprises one (e.g., only one) of the one or more established asset control validation strings.

In certain embodiments, the transaction data corresponds to one or more transactions that have been approved for recordation on the blockchain [e.g., approved (e.g., verified) by at least one transaction node and an asset control node]. In certain embodiments, the transaction data corresponds to at least one of (i) one or more exchanges of at least one asset (e.g., a currency or inventory) and (ii) an authorization to access at least one asset (e.g., an identification) (e.g., wherein the asset is one of the one or more assets corresponding to the asset data). In certain embodiments, (i) at least a portion of the asset data is identification data corresponding to one or more personal identities, (ii) at least a portion of the transaction data corresponds to one or more authorizations to access, records of access, or verifications of identification data, or (iii) both (i) and (ii).

In certain embodiments, the asset data corresponds to at least one of creation, update (e.g., modification), regulation, and deletion of one or more assets (e.g., currency, inventory, or identities). In certain embodiments, the asset data has been provided by an asset control node.

In certain embodiments, the blockchain is a public blockchain.

In some aspects, the present disclosure is directed to a method for recording data in a blockchain with increased security, the method comprising: receiving, by a processor of a computing device, at least a portion of a previously mined outer block [e.g., a previously mined outer block or a hash (e.g., validation string) of a previously mined outer block] and at least a portion of a previously mined inner block [e.g., the previously mined inner block or a hash (e.g., validation string) of the previously mined inner block], wherein the previously mined inner block is recorded on the blockchain; creating, by the processor of the computing device, a new inner block; determining, by the processor of the computing device, a new inner block hash (e.g., a new inner block validation string) based, at least in part, on the at least a portion of a previously mined outer block and the at least a portion of the previously mined inner block; modifying (e.g., writing to), by the processor of the computing device, the new inner block such that the new inner block comprises the new inner block hash; and optionally, storing, by the processor of the computing device, the new inner block on a non-transitory computer readable medium (e.g., in the blockchain).

In certain embodiments, the creating step comprises: receiving, by the processor of the computing device, block data; and modifying, by the processor of the computing device, the new inner block to comprise the block data.

In certain embodiments, the at least a portion of a previously mined outer block comprises a hash (e.g., validation string) of the previously mined outer block. In certain embodiments, the at least a portion of a previously mined inner block comprises a validation string of the previously mined inner block. In certain embodiments, the new inner block hash is a new inner block validation string.

In certain embodiments, the method comprises: creating, by the processor of the computing device, a new outer block comprising the new inner block comprising the new inner block hash (e.g., after the modification step); determining, by the processor of the computing device, a new outer block hash based, at least in part, on the new inner block; modifying (e.g., writing to), by the processor of the computing device, the new outer block such that the new outer block comprises the new outer block hash; and optionally, storing, by the processor of the computing device, the new outer block on a non-transitory computer readable medium.

In certain embodiments, the new outer block comprises outer block data (e.g., stored in a compartment) separate from the new inner block.

In certain embodiments, the method comprises: broadcasting, by the processor of the computing device, over a network to a plurality of computing devices (e.g., a plurality of nodes), the new outer block after the modifying step.

In certain embodiments, the blockchain is a public blockchain. In certain embodiments, the blockchain is a private blockchain.

In some aspects, the present disclosure is directed to a system for recording data in a blockchain with increased security, the system comprising: a processor (e.g., wherein a node comprises the processor); and a non-transitory computer readable medium (e.g., memory) having instructions stored thereon, wherein the instructions, when executed by the processor, cause the processor to: receive at least a portion of a previously mined outer block [e.g., a previously mined outer block or a hash (e.g., validation string) of a previously mined outer block] and at least a portion of a previously mined inner block [e.g., the previously mined inner block or a hash (e.g., validation string) of the previously mined inner block], wherein the previously mined inner block is recorded on the blockchain; create a new inner block; determine a new inner block hash (e.g., a new inner block validation string) based, at least in part, on the at least a portion of a previously mined outer block and the at least a portion of the previously mined inner block; modify (e.g., write to) the new inner block such that the new inner block comprises the new inner block hash; and optionally, store the new inner block on a (e.g., the) non-transitory computer readable medium (e.g., in the blockchain).

In certain embodiments, the instructions, when executed by the processor, cause the processor to create the new block, at least in part, by: receiving, by the processor, block data; and modifying, by the processor, the new inner block to comprise the block data.

In certain embodiments, the at least a portion of a previously mined outer block comprises a hash (e.g., validation string) of the previously mined outer block. In certain embodiments, the at least a portion of a previously mined inner block comprises a validation string of the previously mined inner block. In certain embodiments, the new inner block hash is a new inner block validation string.

In certain embodiments, the instructions, when executed by the processor, cause the processor to: create a new outer block comprising the new inner block comprising the new inner block hash (e.g., after the modification step); determine a new outer block hash based, at least in part, on the new inner block; modify (e.g., write to) the new outer block such that the new outer block comprises the new outer block hash; and optionally, store the new outer block on a (e.g., the) non-transitory computer readable medium.

In certain embodiments, the new outer block comprises outer block data (e.g., stored in a compartment) separate from the new inner block.

In certain embodiments, the instructions, when executed by the processor, cause the processor to: broadcast, over a network to a plurality of computing devices (e.g., a plurality of nodes), the new outer block after the modifying step.

In certain embodiments, the blockchain is a public blockchain. In certain embodiments, the blockchain is a private blockchain.

In some aspects, the present disclosure is directed to a method of being rewarded for adding a block to a blockchain by determining a hash [e.g., a block validation string (e.g., a cryptographic hash satisfying one or more validation conditions) (e.g., demonstrating proof of work)], the method comprising: creating, by a processor of a computing device (e.g., a node), the block comprising block data to be added to the blockchain, wherein the block data comprises mining reward data, wherein the mining rewards data corresponds to a mining reward (e.g., amount of currency or coin) and the mining reward has been determined based, at least in part, on at least one of (i) an amount of time that has elapsed and (ii) a number of blocks that have been added to the blockchain since the computing device previously added (e.g., mined) a block to the blockchain (e.g., such that an operator of the computing device received a prior mining reward); determining, by the processor of the computing device, the hash (e.g., wherein the ash is block validation string) based, at least in part, on the block data; modifying, by the processor of the computing device, the block to comprise the hash; optionally, storing, by the processor of the computing device, the block on a non-transitory computer readable medium; and optionally, broadcasting, by the processor of the computing device, over a network to a plurality of nodes, the block.

In certain embodiments, the mining reward has been determined, at least in part, by a function dependent on the amount of time that has elapsed since the computing device previously added the block to the blockchain (e.g., wherein the amount of time is an input to a step function, an error function, linear function, or asymptotic function that determines the mining reward). In certain embodiments, the mining reward has been determined, at least in part, by a function dependent on the number of blocks that have been added to the blockchain since the computing device previously added the block to the blockchain (e.g., wherein the amount of time is an input to a step function, an error function, linear function, or asymptotic function that determines the mining reward).

In some aspects, the present disclosure is directed to a method of being rewarded for adding a block to a blockchain by determining a hash [e.g., a block validation string (e.g., a cryptographic hash satisfying one or more validation conditions) (e.g., demonstrating proof of work)], the method comprising: creating, by a processor of a computing device (e.g., a node), the block; determining, by the processor of the computing device, the hash based, at least in part, on the block data; modifying, by the processor of the computing device, the block to comprise the hash; creating, by the processor of the computing device, transaction data, wherein the transaction data comprises mining reward data, wherein the mining rewards data corresponds to a mining reward (e.g., amount of currency or coin) and the mining reward has been determined based, at least in part, on at least one of (i) an amount of time that has elapsed and (ii) a number of blocks that have been added to the blockchain since the computing device previously added (e.g., mined) a block to the blockchain (e.g., such that an operator of the computing device received a prior mining reward); optionally, storing, by the processor of the computing device, the block on a non-transitory computer readable medium; and optionally, broadcasting, by the processor of the computing device, over a network to a plurality of nodes, the block.

In certain embodiments, the mining reward has been determined, at least in part, by a function dependent on the amount of time that has elapsed since the computing device previously added the block to the blockchain (e.g., wherein the amount of time is an input to a step function, an error function, linear function, or asymptotic function that determines the mining reward). In certain embodiments, the mining reward has been determined, at least in part, by a function dependent on the number of blocks that have been added to the blockchain since the computing device previously added the block to the blockchain (e.g., wherein the amount of time is an input to a step function, an error function, linear function, or asymptotic function that determines the mining reward).

In some aspects, the present disclosure is directed to a system for being rewarded for adding a block to a blockchain by determining a hash [e.g., a block validation string (e.g., a cryptographic hash satisfying one or more validation conditions) (e.g., demonstrating proof of work)], the system comprising: a processor (e.g., wherein a node comprises the processor); and a non-transitory computer readable medium (e.g., memory) having instructions stored thereon, wherein the instructions, when executed by the processor, cause the processor to: create the block comprising block data to be added to the blockchain, wherein the block data comprises mining reward data, wherein the mining rewards data corresponds to a mining reward (e.g., amount of currency or coin) and the mining reward has been determined based, at least in part, on at least one of (i) an amount of time that has elapsed and (ii) a number of blocks that have been added to the blockchain since the computing device previously added (e.g., mined) a block to the blockchain (e.g., such that an operator of the computing device received a prior mining reward); determining, by the processor of the computing device, the hash (e.g., wherein the ash is block validation string) based, at least in part, on the block data; modifying, by the processor of the computing device, the block to comprise the hash; optionally, storing, by the processor of the computing device, the block on a non-transitory computer readable medium; and optionally, broadcasting, by the processor of the computing device, over a network to a plurality of nodes, the block.

In certain embodiments, the mining reward has been determined, at least in part, by a function dependent on the amount of time that has elapsed since the computing device previously added the block to the blockchain (e.g., wherein the amount of time is an input to a step function, an error function, linear function, or asymptotic function that determines the mining reward). In certain embodiments, the mining reward has been determined, at least in part, by a function dependent on the number of blocks that have been added to the blockchain since the computing device previously added the block to the blockchain (e.g., wherein the amount of time is an input to a step function, an error function, linear function, or asymptotic function that determines the mining reward).

In some aspects, the present disclosure is directed to a system for being rewarded for adding a block to a blockchain by determining a hash [e.g., a block validation string (e.g., a cryptographic hash satisfying one or more validation conditions) (e.g., demonstrating proof of work)], the system comprising: a processor (e.g., wherein a node comprises the processor); and a non-transitory computer readable medium (e.g., memory) having instructions stored thereon, wherein the instructions, when executed by the processor, cause the processor to: create the block; determine the hash based, at least in part, on the block data; modify the block to comprise the hash; create transaction data, wherein the transaction data comprises mining reward data, wherein the mining rewards data corresponds to a mining reward (e.g., amount of currency or coin) and the mining reward has been determined based, at least in part, on at least one of (i) an amount of time that has elapsed and (ii) a number of blocks that have been added to the blockchain since the computing device previously added (e.g., mined) a block to the blockchain (e.g., such that an operator of the computing device received a prior mining reward); optionally, store the block on a non-transitory computer readable medium; and optionally, broadcast, over a network to a plurality of nodes, the block.

In certain embodiments, the mining reward has been determined, at least in part, by a function dependent on the amount of time that has elapsed since the computing device previously added the block to the blockchain (e.g., wherein the amount of time is an input to a step function, an error function, linear function, or asymptotic function that determines the mining reward). In certain embodiments, the mining reward has been determined, at least in part, by a function dependent on the number of blocks that have been added to the blockchain since the computing device previously added the block to the blockchain (e.g., wherein the amount of time is an input to a step function, an error function, linear function, or asymptotic function that determines the mining reward).

In some aspects, the present disclosure is directed to a system for maintaining a blockchain to record transactions in one or more assets, the system comprising: an asset control node [e.g., in a network of nodes (e.g., wherein the asset control node is a registered node)] comprising an asset control module, wherein the asset control module is for writing (e.g., creating) asset data to be stored on the blockchain, wherein the asset data corresponds to at least one of creation, update (e.g., modification), regulation, and deletion of an asset (e.g., currency, inventory, or identities).

In certain embodiments, the asset control module is also for approving and/or rejecting transaction data (e.g., over the network) (e.g., by validating the transaction data) corresponding to one or more transactions of and/or authorizations of access to the asset. In certain embodiments, the transactions, if approved, are stored in memory pool [e.g., to be included in a transaction compartment in a block on the blockchain by a node (e.g., standard node)].

In certain embodiments, the blockchain is a public blockchain.

In certain embodiments, the asset data corresponds to at least one of creation, update (e.g., modification), regulation, and deletion of a plurality of assets (e.g., currency, inventory, or identities).

In certain embodiments, the asset control node writes the asset data by creating data in an asset control compartment to be stored on the blockchain (e.g., wherein the asset control compartment is a block). In certain embodiments, creating the data in the asset control compartment requires payment of an asset fee that is held in a revenue pool from which a dividend is paid to shareholders (e.g., coin holders) once a dividend condition is met.

In certain embodiments, the system comprises an assessor node comprising an assessor module, wherein the assessor module is for monitoring and registering asset control nodes (e.g., thereby providing the asset control nodes access to a valid asset control module). In certain embodiments, the assessor module requires payment of an asset control node registration fee (e.g., in a coin of the system) to register the asset control node [e.g., wherein a portion of the asset control node registration fee is held in reserve (e.g., escrow) as a form of collateral to be used in an event of bad behavior by the asset control node]. In certain embodiments, a portion of the asset control node registration fee is held in a revenue pool from which a dividend is paid to shareholders (e.g., coin holders) once a dividend condition is met.

In certain embodiments, the system comprises a super node comprising a super node module, wherein the super node module is for monitoring and registering assessor nodes. In certain embodiments, the super node is determined by a vote of shareholders (e.g., coin holders).

In certain embodiments, the system comprises one or more transaction nodes [e.g., in the network of nodes (e.g., wherein the one or more transaction nodes are each a registered node)], each transaction node of the one or more transaction nodes comprising a transaction module, wherein the transaction module is for writing (e.g., creating) transaction data to be stored on the blockchain, wherein the transaction data corresponds to one or more transactions and/or authorizations of access (e.g., of and/or to the asset).

In certain embodiments, the asset control module is also for registering the one or more transaction nodes (e.g., thereby providing the one or more transaction nodes access to a valid transaction module).

In certain embodiments, at least one of the one or more transaction nodes further comprises a second transaction module for writing (e.g., creating) second transaction data to be stored on the blockchain, wherein the second transaction data corresponds to one or more transactions of and/or authorizations of access to a second asset (e.g., such that the at least one of the one or more transaction nodes can transact in a plurality of assets comprising the asset and the second asset).

In certain embodiments, the asset control node requires payment of a transaction fee to the asset control node to perform a transaction (e.g., of the asset between two parties) (e.g., for a transaction node to write transaction data to be stored on the blockchain).

In certain embodiments, the transaction module is also for approving and/or rejecting transaction data (e.g., over the network) (e.g., by validating the transaction data) corresponding to one or more transactions of and/or authorizations of access to the asset.

In certain embodiments, the system comprises one or more standard nodes, wherein each standard node of the one or more standard nodes comprises a standard node module and the standard node module is for reading, verifying, and mining blocks (e.g., asset control compartments) on the blockchain.

In certain embodiments, successfully mining the blocks on the blockchain produces a reward (e.g., an amount of coin). In certain embodiments, a portion of the reward is held in a revenue pool from which a dividend is paid to shareholders (e.g., coin holders) once a dividend condition is met. In certain embodiments, the reward is time-dependent (e.g., in accordance with the three method claims given above).

In certain embodiments, at least one of the standard nodes is one or more of the asset control node, a (e.g., the) assessor node, a (e.g., the) super node, one of (e.g., the) one or more transaction nodes.

In some aspects, the present disclosure is directed to a method of recording data on a blockchain used in a system comprising a plurality of nodes, the method comprising: receiving, by a processor of a first standard node, asset data [e.g., corresponding to one or more assets (e.g., currency, inventory, or identities)] that has been written by an asset control node (e.g., wherein the asset data comprises a digital signature of the asset control node); creating, by the processor of the first computing device, an asset control compartment comprising the asset data; determining, by the processor of the first standard node, an asset control validation string based, at least in part, on the asset data; modifying, by the processor of the first standard node, the asset control compartment such that the asset control compartment comprises the asset control validation string; and optionally, storing, by the processor of the first standard node, the asset control compartment (e.g., in order to broadcast the asset control compartment to one or more of the plurality of nodes).

In certain embodiments, the method comprises: receiving, by a processor of a second standard node, the asset control compartment, wherein the asset control compartment comprises the asset control validation string; creating, by the processor of the second standard node, a new outer block comprising the asset control compartment; receiving, by the processor of the second standard node, transaction data [e.g., corresponding to one or more transactions and/or authorizations of access (e.g., of and/or to the one or more assets, respectively)] that has been written by at least one transaction node (e.g., wherein the transaction data comprises a digital signature of the at least one transaction node); creating, by the processor of the second standard node, a transaction compartment such that the transaction compartment comprises the transaction data; modifying, by the processor of the second standard node, the new outer block such that the new outer block comprises the transaction compartment and the asset control compartment, wherein the asset control compartment comprises the asset control validation string; determining, by the processor of the second standard node, a hash based, at least in part, on the transaction compartment and the asset control compartment; and optionally, storing, by the processor of the second standard node, the new outer block (e.g., in order to broadcast the new outer block to one or more of the plurality of nodes).

In certain embodiments, the method comprises: receiving, by a processor of a second standard node, transaction data [e.g., corresponding to one or more transactions and/or authorizations of access (e.g., of and/or to the one or more assets, respectively)] that has been written by at least one transaction node (e.g., wherein the transaction data comprises a digital signature of the at least one transaction node); creating, by the processor of the second standard node, a transaction compartment such that the transaction compartment comprises the transaction data; creating, by the processor of the second standard node, a new outer block comprising the transaction compartment; determining, by the processor of the second standard node, a hash based, at least in part, on the transaction compartment; and optionally, storing, by the processor of the second standard node, the new outer block (e.g., in order to broadcast the new outer block to one or more of the plurality of nodes).

In certain embodiments, the new outer block does not comprise an asset control compartment. In certain embodiments, the transaction data corresponds to a transaction of an asset that corresponds to the asset data.

In certain embodiments, the method comprises: determining, by the processor of the second standard node, the hash based, at least in part, on a digital signature corresponding to the second standard node.

In certain embodiments, the asset data is identification data corresponding to one or more personal identities. In certain embodiments, the transaction data corresponds to one or more authorizations to access, records of access, or verifications of (e.g., the) identification data. In certain embodiments, the transaction data corresponds to at least one of (i) one or more exchanges of at least one asset (e.g., a currency or inventory) and (ii) an authorization to access at least one asset (e.g., an identification) (e.g., wherein the asset is one of the one or more assets corresponding to the asset data). In certain embodiments, the asset data corresponds to at least one of creation, update (e.g., modification), regulation, and deletion of one or more assets (e.g., currency, inventory, or identities).

In certain embodiments, the first standard node is the second standard node.

In certain embodiments, the blockchain is a public blockchain.

In some aspects, the present disclosure is directed to a system for recording data on a blockchain used in a system comprising a plurality of nodes, the system comprising: a first processor (e.g., wherein a first standard node comprises the processor); and a first non-transitory computer readable medium (e.g., memory) having first instructions stored thereon, wherein the first instructions, when executed by the processor, cause the processor to: receive asset data [e.g., corresponding to one or more assets (e.g., currency, inventory, or identities)] that has been written by an asset control node (e.g., wherein the asset data comprises a digital signature of the asset control node); create an asset control compartment comprising the asset data; determine an asset control validation string based, at least in part, on the asset data; modify the asset control compartment such that the asset control compartment comprises the asset control validation string; and optionally, store the asset control compartment (e.g., in order to broadcast the asset control compartment to one or more of the plurality of nodes).

In certain embodiments, the system comprises a second processor (e.g., wherein a second standard node comprises the processor); and a second non-transitory computer readable medium (e.g., memory) having second instructions stored thereon, wherein the second instructions, when executed by the second processor, cause the second processor to: receive the asset control compartment, wherein the asset control compartment comprises the asset control validation string; create a new outer block comprising the asset control compartment; receive transaction data [e.g., corresponding to one or more transactions and/or authorizations of access (e.g., of and/or to the one or more assets, respectively)] that has been written by at least one transaction node (e.g., wherein the transaction data comprises a digital signature of the at least one transaction node); create a transaction compartment such that the transaction compartment comprises the transaction data; modify the new outer block such that the new outer block comprises the transaction compartment and the asset control compartment, wherein the asset control compartment comprises the asset control validation string; determine a hash based, at least in part, on the transaction compartment and the asset control compartment; and optionally, store the new outer block (e.g., in order to broadcast the new outer block to one or more of the plurality of nodes).

In certain embodiments, the system comprises a second processor (e.g., wherein a second standard node comprises the processor); and a second non-transitory computer readable medium (e.g., memory) having second instructions stored thereon, wherein the second instructions, when executed by the second processor, cause the second processor to: receive transaction data [e.g., corresponding to one or more transactions and/or authorizations of access (e.g., of and/or to the one or more assets, respectively)] that has been written by at least one transaction node (e.g., wherein the transaction data comprises a digital signature of the at least one transaction node); create a transaction compartment such that the transaction compartment comprises the transaction data; create a new outer block comprising the transaction compartment; determine a hash based, at least in part, on the transaction compartment; and optionally, store the new outer block (e.g., in order to broadcast the new outer block to one or more of the plurality of nodes).

In certain embodiments, the new outer block does not comprise an asset control compartment. In certain embodiments, the transaction data corresponds to a transaction of an asset that corresponds to the asset data.

In certain embodiments, the second instructions, when executed by the second processor, cause the second processor to: determine the hash based, at least in part, on a digital signature corresponding to the second processor (e.g., the second standard node).

In certain embodiments, the asset data is identification data corresponding to one or more personal identities. In certain embodiments, the transaction data corresponds to one or more authorizations to access, records of access, or verifications of (e.g., the) identification data. In certain embodiments, the transaction data corresponds to at least one of (i) one or more exchanges of at least one asset (e.g., a currency or inventory) and (ii) an authorization to access at least one asset (e.g., an identification) (e.g., wherein the asset is one of the one or more assets corresponding to the asset data). In certain embodiments, the asset data corresponds to at least one of creation, update (e.g., modification), regulation, and deletion of one or more assets (e.g., currency, inventory, or identities).

In certain embodiments, the second processor is the first processor and the second non-transitory computer readable medium is the first non-transitory computer readable medium. In certain embodiments, the blockchain is a public blockchain.

### Definitions

In order for the present disclosure to be more readily understood, certain terms used herein are defined below. Additional definitions for the following terms and other terms may be set forth throughout the specification.

In this application, the use of “or” means “and/or” unless stated otherwise. As used in this application, the term “comprise” and variations of the term, such as “comprising” and “comprises,” are not intended to exclude other additives, components, integers or steps. As used in this application, the terms “about” and “approximately” are used as equivalents. Any numerals used in this application with or without about/approximately are meant to cover any normal fluctuations appreciated by one of ordinary skill in the relevant art. In certain embodiments, the term “approximately” or “about” refers to a range of values that fall within 25%, 20%, 19%, 18%, 17%, 16%, 15%, 14%, 13%, 12%, 11%, 10%, 9%, 8%, 7%, 6%, 5%, 4%, 3%, 2%, 1%, or less in either direction (greater than or less than) of the stated reference value unless otherwise stated or otherwise evident from the context (except where such number would exceed 100% of a possible value).

Asset: As used herein, the term “asset” refers to property owned or associated with one or more entities (e.g., individuals). An asset may be tangible or intangible. An asset may have extrinsic or intrinsic value. An asset may be transferable or non-transferable. In certain embodiments, an asset is or has a monetary value (e.g., is a currency). An asset may be, for example, a set of one or more titles, deeds, contracts, smart contracts, debts, objects (e.g., collectibles), commodities, products, equities, shares, or bonds. An asset may be, for example, a particular currency, inventory, or set of identities. A set of identities can be a set of identities corresponding to persons registered with an entity (e.g., a private 3^{rd} party entity or a government).

Transaction: As used herein, the term “transaction” refers to a transfer, record, or authorization of access of one or more assets. A transaction can be a transfer of one or more assets between one or more parties. For example, a transaction can be a sale of one asset for an amount of another asset (e.g., sale of a car for currency). A transaction can be a record of access and/or authorization of access of data corresponding to one or more assets. For example, if identifications are stored as an asset, a transaction can be a record of access of identification data associated with an individual and/or authorization of access to the identification data.

Transaction compartment: As used herein, the term “transaction compartment” refers to a data structure (e.g., a record) used to store transaction data that corresponds to one or more transactions.

Asset control compartment: As used herein, the term “asset control compartment” refers to a data structure (e.g., a record) used to store asset data that corresponds to one or more assets. Asset data can correspond to a creation, update (e.g., modification), regulation, or deletion of an asset. An asset control compartment may be a block in a blockchain (e.g., a blockchain of asset control compartment).

Outer block: As used herein, the term “outer block” refers a data structure (e.g., a record) that is stored in a sequential, linked order as part of a blockchain and comprises at least one of a transaction compartment and an asset control compartment. In certain embodiments, a blockchain is a blockchain of outer blocks. The size of outer blocks in a system may be fixed or variable. In certain embodiments, a blockchain of outer blocks comprises a blockchain of asset control compartments.

Hash: As used herein, the term “hash” refers to its conventional meaning in computer science and, specifically, blockchain technology. A hash may be a bit string of a fixed size. In certain embodiments, a block comprises a hash that is based, at least in part, on data (e.g. all of the data) in the block (e.g., wherein the block is an outer block that comprises a transaction compartment and does or does not comprise an asset control compartment) and, optionally, data (e.g., all of the data) in one or more previous blocks (e.g., a hash in one or more previous blocks). In certain embodiments, a hash is a cryptographic hash (e.g., is based on a cryptographic hashing algorithm). For example, a hash can be based on SHA-256 or SHA-512.

Validation String: As used herein, the term “validation string” refers to a hash (e.g., bit string) that demonstrates proof of work, where proof of work is taken to have its conventional meaning in the art of blockchain technology. A validation string may be a bit string of a fixed size. For example, a validation string can be a SHA hash (e.g., SHA-256 or SHA-512 hash) of data in a block that satisfies a difficulty threshold (e.g., is lower than a target).

Blockchain: As used herein, the term “blockchain” refers to a data structure comprising a set of blocks that are linked together. In certain embodiments, one or more (e.g., all) of the blocks in blockchain comprise a validation string. In certain embodiments, a blockchain comprises outer blocks that comprise one or more inner blocks (e.g., an asset control compartment) that comprise a validation string. In certain embodiments, a blockchain is a public blockchain (e.g., thereby providing increased transparency and trust in a system and/or method disclosed herein). In certain embodiments, a blockchain is a private (e.g., semi-private) blockchain.

Digital Signature: As used herein, the term “digital signature” refers to data that securely identifies a signer (e.g., an individual, an entity, or a node). As non-limiting examples, a digital signature can be based on any one or more of an RSA key algorithm, a PGP key algorithm, a GPG key algorithm, a Diffie-Hellman key algorithm, a Digital Signature Algorithm (Digital Signature Standard), an elliptic curve technique, a Paillier cryptosystem, and a Cramer-Shoup cryptosystem. For example, a digital signature may be public key of an individual, entity, or node that has a corresponding private key (e.g., which are parts of a PGP encryption protocol).

Node: As used herein, the term “node” refers to any computing device capable of joining a network to transmit and receive data across the network. In certain embodiments, a node comprises a processor and a non-transitory computer readable medium having instructions stored thereon, wherein the instructions, when executed by the processor, cause the processor to perform steps in the instructions. A node can be, for example, a computer (e.g., a person computer), a server, or a mobile computing device. A node may be permissioned such that it comprises one or more modules that provide functionality to the node. Module may be received by a node once permissioned or may be made functional once permissioned. A node may need to be registered with a system in order to join a network for the system.

Mine: As used herein, the term “mine” (as in mining a block) refers to a process of producing a valid block (e.g., outer block or asset control compartment) for recordation on a blockchain. In certain embodiments, mining comprises determining a hash based, at least in part, on data in a block. In certain embodiments, mining comprises creating a block comprising data and/or modifying a block to comprise data. A reward may be given for mining a block. Mining may produce a validation string (thereby establishing proof of work) and/or may produce a hash based in part on a digital signature of the mining node. A miner is a node of a system that mines blocks. “Miner”, “miner node”, and “mining node” are used interchangeably herein. In certain embodiments, mining comprises determining (e.g., verifying) the validity of data included in a block that has been created prior to hashing the block (e.g., producing a validation string for the block).

### BRIEF DESCRIPTION OF THE DRAWING

Drawings are presented herein for illustration purposes, not for limitation. The foregoing and other objects, aspects, features, and advantages of the disclosure will become more apparent and may be better understood by referring to the following description taken in conjunction with the accompanying drawings, in which:

FIG. 1A and FIG. 1B are diagrams illustrating a relationship between a transaction compartment and an asset control compartment in a blockchain, according to illustrative embodiments of the disclosure;

FIGS. 2A-2D shows exemplary functional relationships between mining reward and time, according to illustrative embodiments of the disclosure;

FIG. 3 is a flow diagram of an exemplary method for recording data in a blockchain, according to illustrative embodiments of the disclosure;

FIG. 4 is a flow diagram of an exemplary method for recording data in a blockchain, according to illustrative embodiments of the disclosure;

FIG. 5 is a block diagram illustrating relationships between various nodes in an exemplary system and data structures of a blockchain, according to illustrative embodiments of the disclosure;

FIG. 6A is a diagram of relationships between an asset control node, standard nodes, and transaction nodes, according to illustrative embodiments of the disclosure;

FIG. 6B is a diagram of a node registering with an assessor node to be an asset control node, according to illustrative embodiments of the disclosure;

FIG. 7 is a diagram of a transaction being made between Person 1 and Person 2, according to illustrative embodiments of the disclosure;

FIG. 8A is a detailed diagram of a transaction being approved for recordation, according to illustrative embodiments of the disclosure;

FIG. 8B is a detailed diagram of a transaction being added to a transaction compartment of an outer block, according to illustrative embodiments of the disclosure;

FIG. 8C is a detailed diagram of an outer block being, according to illustrative embodiments of the disclosure;

FIG. 9 is a flow diagram of an exemplary method for using a system comprising an asset control node, transaction node, and standard node to create blocks in a blockchain, according to illustrative embodiments of the disclosure;

FIG. 10 is a diagram of relationships for a blockchain to generate and distribute revenue, according to illustrative embodiments of the disclosure;

FIG. 11 is a diagram of relationships between coin holders, a blockchain system, a revenue pool of the blockchain system, and a super node, according to illustrative embodiments of the disclosure;

FIG. 12 is a block diagram of an example network environment for use in the methods and systems described herein, according to illustrative embodiments of the disclosure; and

FIG. 13 is a block diagram of an example computing device and an example mobile computing device, for use in illustrative embodiments of the disclosure.

### DETAILED DESCRIPTION

It is contemplated that systems, devices, methods, and processes of the claimed invention encompass variations and adaptations developed using information from the embodiments described herein. Adaptation and/or modification of the systems, devices, methods, and processes described herein may be performed by those of ordinary skill in the relevant art.

Throughout the description, where articles, devices, and systems are described as having, including, or comprising specific components, or where processes and methods are described as having, including, or comprising specific steps, it is contemplated that, additionally, there are articles, devices, and systems of the present disclosure that consist essentially of, or consist of, the recited components, and that there are processes and methods according to the present disclosure that consist essentially of, or consist of, the recited processing steps.

It should be understood that the order of steps or order for performing certain action is immaterial so long as operability is not lost. Moreover, two or more steps or actions may be conducted simultaneously.

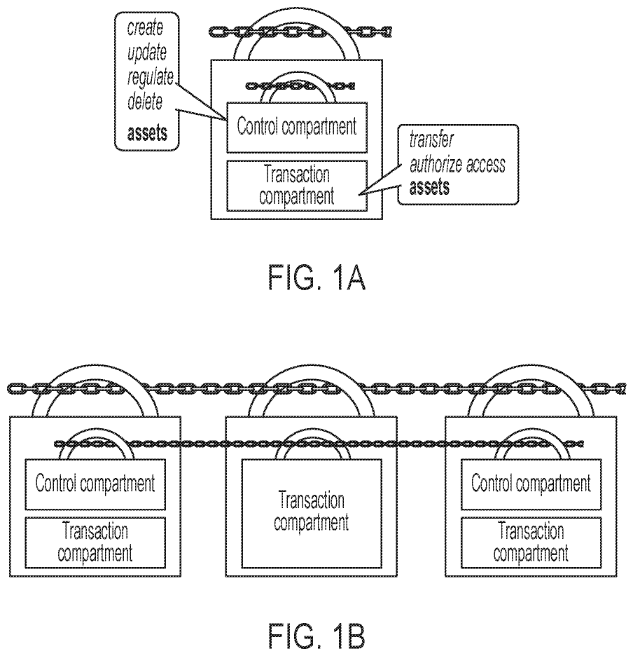

In certain embodiments, systems and methods disclosed herein use blocks comprising a hierarchy of data structures to store data on a blockchain, referred to herein as outer blocks. Outer blocks allow asset data for one or more assets to be stored to the ledger separately from transaction data for transactions of the one or more assets. FIGS. 1A and 1B are diagrams showing the relationship between outer blocks, asset control compartments and transaction compartments.

FIG. 1A shows a single outer block that comprises a control compartment and a transaction compartment. The asset control compartment comprises asset data corresponding to one or more assets. The asset data identifies which asset it corresponds to (e.g., by presence of a digital signature). The transaction compartment comprises transaction data corresponding to one or more transactions of one or more assets (e.g., one or more of the one or more assets in the asset control compartment). The transaction data identifies which asset is being transacted. In the outer block, asset data and transaction data are isolated from each other by using the separate asset control compartment and transaction compartment structures.

Asset control compartments may be used to store asset data. In certain embodiments, a single asset control compartment comprises asset data corresponding to only one asset. In certain embodiments, a single asset control compartment comprises asset data corresponding to a plurality of assets (e.g., written by a plurality of asset control nodes each separately controlling each of the plurality of assets). Asset data may correspond to the creation, update (e.g., modification), regulation, or deletion of an asset. For example, if an asset used in a system is a currency, asset data may be creation of an amount of the currency or deletion of an amount of the currency. For example, if an asset is a type of identification, asset data can be creation of identifications of one or more individuals, deletion of identifications of one or more individuals, or a modification of stored data related to individuals. An asset may be a product or other inventory. Therefore, as another example, data corresponding to modification of product information for a particular inventory may be stored in an asset control compartment.

Transaction compartments may be used to store transaction data. Generally, although not necessarily, a transaction compartment comprises transaction data corresponding to a plurality of transactions. A single transaction may involve a plurality of assets. For example, a purchase may be stored as transaction data in a transaction compartment, wherein the purchase involves an exchange of a currency asset between two parties and an exchange of ownership of a product asset between the two parties. In certain embodiments, transaction compartments comprise only transactions which have been approved for storing (e.g., as described below). A transaction may be a record of access or authorization to access data stored as an asset within a system. For example, if an asset stored within a system is a particular type of identification of individuals, then a transaction may be an authorization to access the identification of one or more of the individuals. For example, a government may store citizen IDs as an asset and a transaction may be an authorization for a 3^{rd} party to access one or more of those citizen IDs.

FIG. 1B is a diagram of a portion of a blockchain showing three outer blocks. The first (leftmost) outer block comprises an asset control compartment and a transaction compartment. The middle outer block comprises a transaction compartment and not an asset control compartment. The last (rightmost) outer block comprises an asset control compartment and a transaction compartment. Although shown with only one middle outer block, in certain embodiments, a blockchain comprises a plurality (e.g., at least 10, at least 100, at least 500, at least 1000, or more) of such middle outer blocks (outer blocks comprising a transaction compartment and not an asset control compartment) between outer blocks comprising an asset control compartment. A system may control the relative frequency of asset control compartments on a blockchain. For example, a system may facilitate creation of outer blocks comprising asset control compartments every several minutes (e.g., about every 5 minutes, 10 minutes, 15 minutes, or 20 minutes) and creation of one or more outer blocks comprising a transaction compartment and not an asset control compartment about every second. This can be controlled, for example, by establishing a proof of work for mining a block (e.g., an asset control compartment) with a difficulty threshold that causes a new asset control compartment to be mined to a blockchain with a desired frequency, whereas outer blocks that do not comprise asset control compartments do not require proof of work to be established to be considered valid and therefore are added to the blockchain much more rapidly.

In certain embodiments, outer blocks are rapidly mined because establishing proof of work is not necessary to produce a valid outer block. That is, in certain embodiments, when an outer block is mined, a hash is produced, but the hash does not demonstrate proof of work (i.e., the hash is not a validation string). Since hashes can be produced rapidly for moderate amounts of data, outer blocks can be mined rapidly. In order to promote security and transparency for a system, a system may require miners of outer blocks to sign outer blocks that they mine. For example, a miner may sign an outer block by determining a hash based, at least in part, on a digital signature of the miner. In certain embodiments, a mining node determines a hash for a block, based at least in part, on a digital signature of the mining node (e.g., wherein the mining node modifies the block to comprise its digital signature prior to determining the hash). In certain embodiments, a mining node modifies a block to comprise a digital signature of the mining node after determining a hash based, at least in part, on data in the block.

To further promote security and transparency for a system, an outer block may be verified by one or more verification nodes in the system to verify their validity (e.g., before or after a mining node determines a hash). A digital signature of any verifying nodes may be stored in the outer block (e.g., in a header of the outer block). Any verifying node may send verification data (e.g., comprising a digital signature of the verifying node) to the miner node to be included in the outer block header. In certain embodiments, a verifying node verifies data and/or a hash of the data. For example, a verifying node may verify the validity of a hash (based on the underlying data). For example, a verifying node may verify the validity of data in a block (e.g., an outer block comprising a transaction compartment) by checking the data against a list of approved data to be recorded (e.g., data in a memory pool), such as approved transaction data (e.g., in a memory pool). In certain embodiments, a mining node mines a block (e.g., an outer block) at least in part by determining a hash, one or more verifying nodes verify the data in the block as well as the hash, and then the one or more verifying nodes add verification data comprising their digital signature(s) to the block (e.g., by sending their digital signature(s) to the mining node for the mining node to modify the block to comprise the digital signature(s)). In certain embodiments, a mining node determines a hash based, at least in part, on verification data comprising a digital signature of each of one or more verifying nodes (e.g., that have verified the data on which the hash is to be based). In certain embodiments, a hash for an outer block is based, at least in part, on verification data comprising a digital signature of each of one or more verification nodes that is in a previous outer block (e.g., thereby providing increased security to the verification data in the previous outer block).

Outer blocks in a blockchain may be linked by producing a hash for a new outer block being mined that is based, at least in part, on the data in a previous block (e.g., a hash thereof). In this way, outer blocks may be linked in a blockchain, but with higher frequency than typical proof-of-work based blockchain technologies by eliminating the need to establish proof of work. Digital signatures of one or more verifying nodes may be added to an outer block header after the outer block is created and hashed such that the hash determined for the next outer block is based, at least in part, on the digital signatures of the one or more verifying nodes (e.g., thereby preventing tampering). Since, in certain embodiments, certain outer blocks comprise an asset control compartment, the next outer block mined after an outer block that comprises an asset control compartment will comprise a hash that is based, at least in part, on the data in the asset control compartment.

The frequency with which outer blocks comprising asset control compartments are mined may be limited by the frequency with which valid asset control compartments are mined. In certain embodiments, mining an asset control compartment requires producing a validation string, thereby establishing proof of work. Proof of work may be established using any known protocol. For example, an integral nonce may be used to produce hashes of data in an asset control compartment until a hash that meets or exceeds a difficulty threshold is produced. The hash that meets or exceeds the difficulty threshold then is a validation string. In certain embodiments, once a validation string is produced, an asset control compartment has been mined. The asset control compartment is then available to be broadcast for addition in an outer block. In certain embodiments, a system is set up to have an asset control compartment mined with a certain frequency regardless of whether there is asset data to be included in the asset control compartment or not. For example, a system may produce a mined asset control compartment about every 10 minutes (e.g., in part by modulating a difficulty threshold for producing a validation string). Therefore, many outer blocks comprising transaction compartments and not asset control compartments may be mined to a blockchain between outer blocks comprising an asset control compartment.

Additional security may be provided to a system by requiring miners to produce a validation string for an asset control compartment based, at least in part, on a previous outer block (e.g., a hash thereof). Therefore, in certain embodiments, a validation string of an asset control compartment is based, at least in part, on an immediately preceding outer block and a validation string of an immediately preceding asset control compartment. For example, referring to FIG. 1B, the asset control compartment in the last (rightmost) outer block has been mined such that that asset control compartment comprises a validation string based, at least in part, on both the middle outer block and a validation string of the asset control compartment in the first (leftmost) outer block. As discussed above, there may be many such middle outer blocks in other cases and, analogous to FIG. 1B, a validation string of an asset control compartment in a last outer block may be based on the last such middle outer block.

In certain embodiments, since the hash of each outer block is based, at least in part, on the outer block that immediately precedes it (e.g., a hash thereof) on a blockchain, asset control compartments with validation strings based at least in part on a previous outer block act to provide proof of work that further secures the validity of any and all outer blocks between asset control compartments on the blockchain. Outer blocks can be linked and secured by their respective hashes and digital signatures (of the miner and any verifying nodes). Asset control compartments can be linked and secured by their respective validation strings that each establish proof of work and, if the validation strings are based, at least in part, on previous outer blocks, that proof of work further secures the outer blocks (e.g., against data manipulation). In certain embodiments, use of digital signatures and multi-node verification for outer blocks provides an initial layer of security that is more than sufficient for short time periods (e.g., less than about 10 minutes) while proof of work established for asset control compartments provides robust long term security. Such systems and methods can allow for many transactions to be recorded rapidly (e.g., every second) while securing them using proof of work on a slightly longer time scale [e.g., every several (e.g., about 10) minutes]. In contrast, conventional systems, such as Bitcoin, are severely limited in the rate with which transactions can be recorded as proof of work must be established to record any transaction. The rate with which asset control compartments are mined (e.g., with or without asset data therein) can be moderated to optimize security of a system.

Without wishing to be bound to any particular theory, a reduction in the overall amount of proof of work that must be established to record transactions can also reduce the overall energy usage of a system. For example, a hash of an outer block can be produced with minimal energy consumption if the hash does not need to also establish proof of work. In certain embodiments, appreciable energy consumption is only required when mining asset control compartments, where proof of work must be established. Moreover, in certain embodiments, a reward for mining a new block is not fixed, which can reduce overall power consumption of a system.

A reward for mining a block may depend on the last time that a miner has successfully mined a block, wherein the reward is reduced to a time-dependent fractional amount for a period of time after the last time. Time can be measured in absolute terms (e.g., hours or minutes) or relative terms (e.g., a number of blocks since the last block a miner has added to a blockchain). A time-variable mining reward can follow any of a variety of functional relationships, such as, for example, a step-function, an error function, an asymptotic function, or a linear function. A system or method can use an estimated time since a last block was mined by a miner to determine a time-variable mining reward, wherein the estimated time is rounded (e.g., to a nearest minute or nearest hour). In conventional systems where the mining reward is fixed, each node is incentivized to constantly attempt to mine new blocks in order to maximize its revenue. Time-variable mining rewards incentivize nodes to temporarily cease mining activity since the reward for a quickly mined second block may be less than (or only approximately) the same as the cost of energy consumption to the node to perform the mining. Such systems and methods can thereby reduce overall power consumption since it is likely that not all nodes within a system will be mining simultaneously.

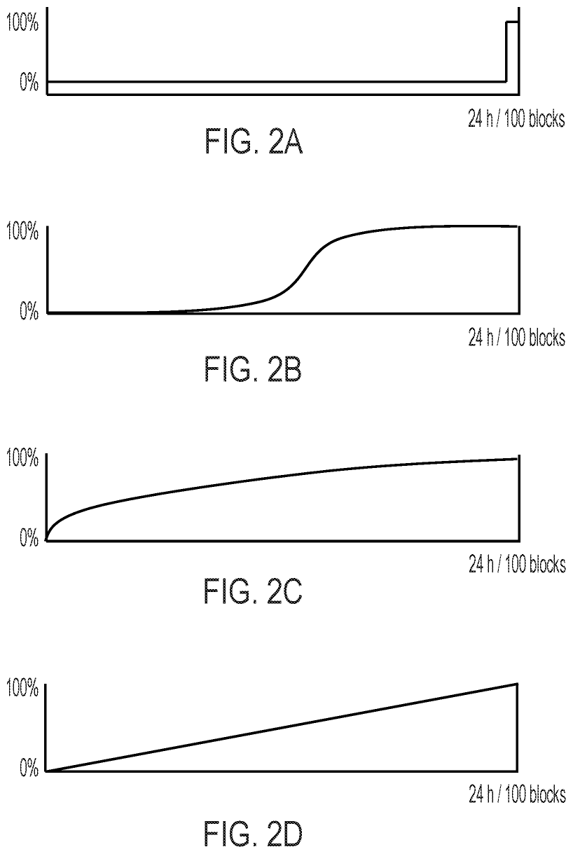

FIGS. 2A-2D show a variety of exemplary functions that may be used to determine a time-variable mining reward. Each function output is plotted as a percentage of a full reward that a miner would receive for mining a second block and each function input is plotted as a period of time since the miner last mined a block. As shown, a step function (FIG. 2A), an error function (FIG. 2B), an asymptotic function (FIG. 2C), or a linear function (FIG. 2D) may be used, for example. The plots in FIGS. 2A-2D are shown such that x-axis is labeled in the alternative as running from 0 to 24 h or alternatively 0 to 100 blocks. These values are arbitrary and chosen to demonstrate that the time-dependence can be absolute (e.g., number of hours) or relative (e.g., number of blocks). Therefore, the values themselves can be any amount suitable for use in a particular system. For example, a mining reward may return to being full value for a particular mining node after no more than about 1 hour, 2 hours, 4 hours, 6 hours, 12 hours, 18 hours, or 24 hours. For example, a mining reward may return to being full value for a particular mining node after no more than about 10 blocks, 20 blocks, 50 blocks, 100 blocks, 500 blocks, or 1000 blocks. The blocks may be outer blocks or asset control compartments.

In certain embodiments, a reward for mining an asset control compartment is substantially higher than a reward for mining an outer block (e.g., because mining the asset control compartment requires establishing proof of work while mining the outer block does not). In certain embodiments, a portion of the reward for mining an asset control compartment is reserved to be distributed amongst miners of outer blocks that are added to a blockchain after the asset control compartment has been mined (e.g., and added to the blockchain) and before a second asset control compartment has been mined (e.g., and added to the blockchain). In certain embodiments, nodes that verify outer blocks also get a portion of a reward received for mining the immediately previous asset control compartment. For example, referring to FIG. 1B again, the node that mines the middle outer block and/or the node that mines the first (leftmost) outer block may receive a portion of the reward received for mining the asset control compartment within the first outer block. For example, any node that verifies the first or middle outer block may also receive a portion of the reward. The number of nodes that can get a reward for verifying an outer block may be limited to a set amount (e.g., about first 5 nodes) or limited by time (e.g., within about 0.5 seconds). In certain embodiments, outer blocks are mined at a rate such that, in practice, the number of nodes that verify a particular outer block is effectively limited by the time it takes for a new outer block to be mined, but the number of verifications is not actually (e.g., systemically) limited. In certain embodiments, verifying nodes must be unanimous in agreement of validity in order for a block to be recorded on a blockchain.

The portion of reward for mining an asset control compartment given to miners (and/or verifiers) of outer blocks may be a fixed amount that is substantially less than the full amount or it may be part of a fixed percentage of the full reward (e.g., wherein the portion is a fixed percentage regardless of how many miners (and/or verifiers) of subsequent outer blocks ultimately share in the portion). In certain embodiments, if a portion of a reward that is paid to miners (and/or verifiers) of subsequent outer blocks is part of a percentage of the reward for mining an asset control compartment, then the miner of the asset control compartment can be paid immediately (e.g., by including a transaction to the miner in the transaction compartment of the outer block that comprises the asset control compartment, similarly to as is done with Bitcoin). In certain embodiments, if an amount that each miner (and/or verifier) of subsequent outer blocks receives is fixed, then the miner of an asset control compartment will be paid once the next asset control compartment is mined (e.g., as a transaction in the block that comprises the next asset control compartment).

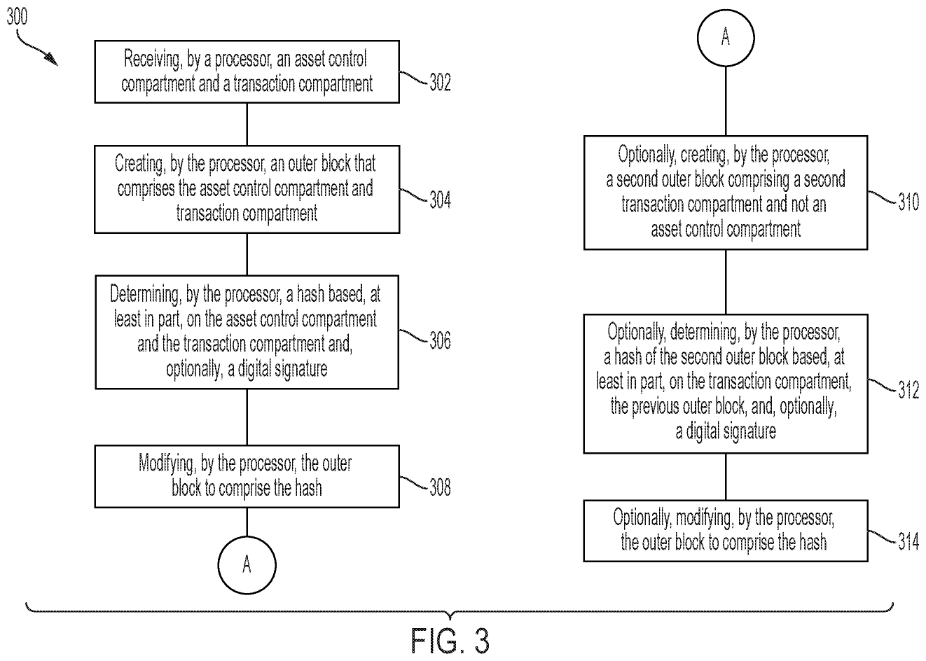

FIG. 3 is a flow diagram of exemplary method 300 for recording data on a blockchain. In step 302, a node receives, by a processor of the node, an asset control compartment and a transaction compartment. The asset control compartment comprises asset data corresponding to one or more assets and may comprise an asset control compartment validation string. In certain embodiments, the node has itself mined the asset control compartment. In certain embodiments, the node itself creates a transaction compartment by receiving (e.g., retrieving) transaction data from a list of approved transactions (e.g., as discussed in further detail below). In certain embodiments, the node also receives, by its processor, a hash of a previous outer block (e.g., the last outer block currently on the blockchain). In step 304, the node creates an outer block that comprises at least the asset control compartment and transaction compartment and, if received, the hash of the previous outer block.

In step 306, the node determines, by its processor, a hash based, at least in part, on the asset control compartment (e.g., and a validation string that the asset control compartment comprises) and the transaction compartment In certain embodiments, the hash is also based, at least in part, on a digital signature of the node and/or a hash of a previous outer block (e.g., the last outer block currently on the blockchain). In step 308, the node modifies, by its processor, the outer block to comprise the hash. In certain embodiments, one or more verifying nodes verify a newly created outer block (e.g., to determine that the hash is valid and/or that the data within the outer block is valid). In certain embodiments, any verifying node modifies the outer block to comprise a digital signature of the verifying node.

In certain embodiments, exemplary method 300 comprises optional steps 310, 312, and 314. In certain embodiments, a second node (different from the node that performs step 302, 304, 306, and 308) performs step 310, 312, and 314. In step 310, a second outer block is created that comprises a second transaction compartment and not an asset control compartment. In step 312, a hash of the second outer block is determined based, at least in part, on the transaction compartment, the previous outer block (from steps 304, 306, and 308), and, optionally, a digital signature of the node that is hashing (and created) the second outer block. In step 314, the outer block is modified to comprise the hash determined in step 312.

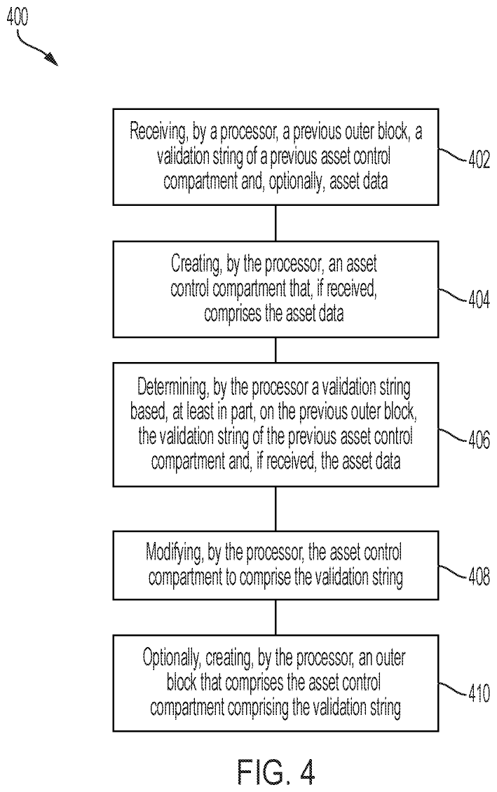

FIG. 4 shows an exemplary method 400 for storing data on a blockchain that provides security of outer blocks on a blockchain based on an embedded blockchain of inner blocks (e.g., an asset control compartment). In step 402, a processor of a node receives at least (i) at least a portion of a previous outer block (e.g., the whole block or a hash thereof), (ii) a validation string, and (iii) optionally, asset data. In step 404, the node creates an asset control compartment that comprises the asset data, if received. In step 406, the node determines a validation string for the asset control compartment based, at least in part on, (i) the validation string of the previous asset control compartment, (ii) the previous outer block, and (iii) the asset data, if received. In step 408, the asset control compartment is modified to comprise the validation string determined in step 406. In optional step 410, the node creates a new outer block that comprises the asset control compartment (after modification in step 408). It is understood that the general relationship between inner and outer blocks used in this exemplary method can be applied whether the inner block is an asset control compartment or a different, generic inner block.

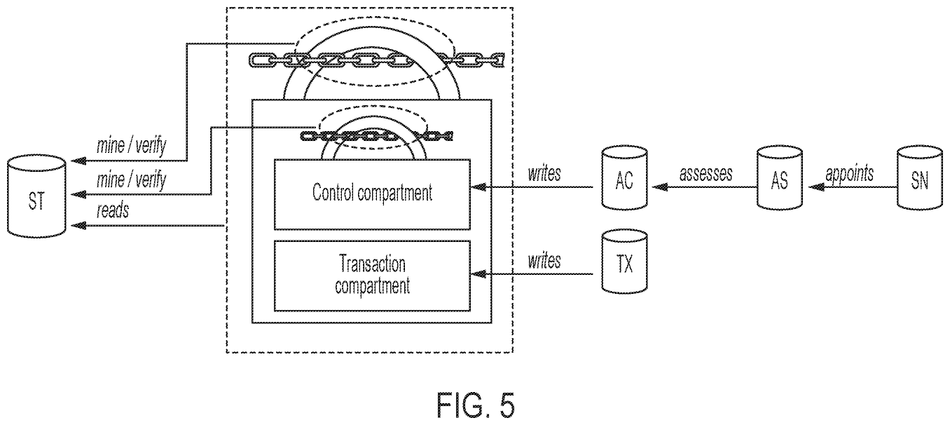

Referring now to FIG. 5, in certain embodiments, a system comprises a plurality of nodes for recording data in a blockchain. In a system in accordance with FIG. 3, a standard node (ST) is permissioned to mine and/or verify outer blocks and asset control compartments using a standard module. The standard module can also read outer blocks on the blockchain (e.g., for auditing purposes). A transaction node (TX) comprises a transaction module for writing transaction data. The transaction data is stored in transaction compartment(s) within outer block(s) in the blockchain (e.g., as described further below). An asset control node (AC) comprises an asset control module for writing asset data to be stored in asset control compartment(s). In certain embodiments, (e.g., in order to limit extraneous asset data writing operations, such as creation of assets) an asset control node must be a fee to write asset data. In certain embodiments, each asset control node provides a digital signature as part of any asset data it writes, so that the respective asset can be identified when reading the asset data. An assessor node (AS) assesses the asset control node in order to limit (or eliminate) bad faith behavior by the asset control node. A super node (SN) is responsible for appointing one or more nodes to be assessor nodes. The super node can also revoke permission of an assessor node. A single node can be one or more of a standard node, a transaction node, an asset control node, an assessor node, and a super node.

In certain embodiments, an asset control node writes asset data to be recorded on a blockchain. The asset data may be written and may include a digital signature of the asset control node (e.g., for authentication purposes). The digital signature may be used to determine which asset the asset data corresponds to. In certain embodiments, asset data that is written by an asset control node is added to a list of asset data (e.g., stored in a memory pool). In certain embodiments, one or more standard nodes pull data from a list of asset data that has been written and create and mine asset control compartments that comprise the asset data. In certain embodiments, mining an asset control compartment comprises establishing proof of work by determining a validation string for the asset control compartment. In certain embodiments, asset control compartments are created and mined analogously as blocks in Bitcoin are created and mined.

In certain embodiments, a system comprises a super node. In certain embodiments, a system comprises only one super node. In certain embodiments, a vote of shareholders (e.g., as discussed further below) is held to determine a (e.g., the) super node. For example, a motion for an election may require a vote of at least a certain percentage of shareholders and then an election is held where. A scheme that may be used for voting is fractional representation where each shareholder votes in proportion to the percentage of shares that he/she owns.

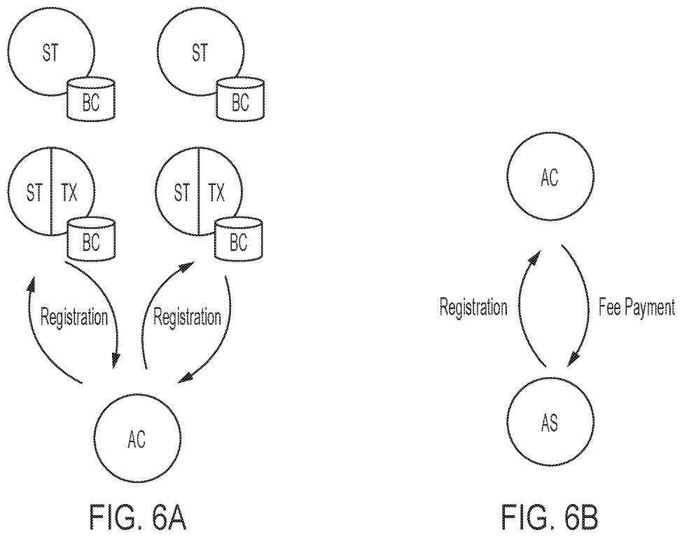

FIG. 6A is a diagram that shows the relationship between five nodes in an exemplary system, wherein one of the nodes is an asset control node (AC). Two nodes are standard nodes (ST) only. This means that they can mine and/or verify blocks and each maintain their own copy of the blockchain of outer blocks in the system (represented by the blockchain symbol “BC” in the figure). Two nodes have been registered by the asset control node (AC) to be transaction nodes (TX) for the asset that the asset control node controls. The transaction nodes comprise a transaction module for writing transaction data to be stored in transaction compartments on the blockchain. Transaction nodes are registered by requesting an asset control node to be registered and receiving permission from the asset control node to be registered. An asset control node may use an criteria it desires to determine whether to register (permission) a node as an asset control node. An asset control node may (or may not) require payment of a fee by a node to register as a transaction node. Any one or more of the nodes shown may be transaction nodes for one or more other assets (e.g., that are controlled by asset control node(s) not shown).

In certain embodiments, a node becomes an asset control node by registering through an assessor node. FIG. 6B is a diagram that shows a node being registered as an asset control node (AC) by an assessor node (AS). The assessor node may have been appointed by a super node (not shown). A node requests to an assessor node to register as an asset control node for a certain asset. After receiving a request from a node to register as an asset control node, an assessor node then assesses whether the node should be registered. In certain embodiments, a node can create an unlimited number of assets once approved by an assessor to be an asset control node (although the assessor node for the asset control node may also be able to revoke permission from the asset control node if too many assets are created). An assessor node (e.g., the assessor node shown in FIG. 6B) may be appointed by a super node.

In certain embodiments, registration to be an asset control node requires payment of a fee to an assessor node. A portion of the fee may go into a revenue pool for a system (e.g., as described in detail below). A portion of the fee may be held by the assessor node in an escrow-type account such that any bad faith action by the asset control node results in the assessor paying a penalty to the revenue pool.

The assessment of a node by an assessor node can be based on any criteria, but typically requires human interaction. The use of a human assessment of potential asset control nodes can help increase trust and in a system. An assessor may require an in person meeting (or phone conference), an inspection of the physical computing device or server that will be used, a test of electronic and/or physical security of the node, or other similar physical assessments. In certain embodiments, an assessor may require a contract to be signed (e.g., a smart contract) prior to registering a node as an asset control node. In certain embodiments, human interaction (e.g., physical assessment) of a node can allow better assessment, as remote electronic assessment can be tricked or otherwise bypassed by nodes acting in bad faith.

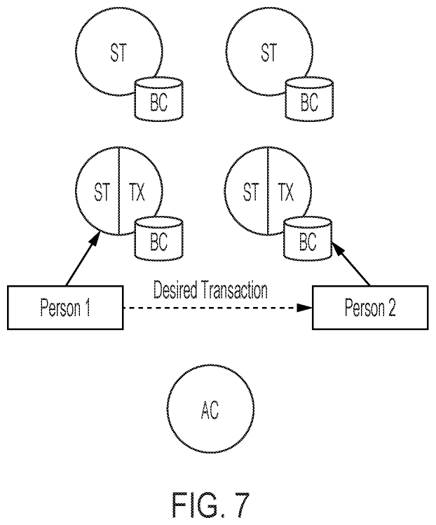

Once a system comprises an asset control node permissioned to write asset data corresponding to an asset and one or more transaction nodes registered (permissioned) to write transaction data corresponding to transactions of the asset, then the system is operable to record transactions of the asset. FIG. 7 is a diagram of an exemplary system (e.g., one that has been established as described in relation to FIGS. 6A and 6B above) used to record a transaction between Person 1 and Person 2. Person 1 and Person 2 desire to exchange an amount of an asset controlled by the asset control node (AC). For example, Person 1 may want to send 5 coins (or, alternatively, dollars or items) to Person 2. Person 2 may or may not also send an asset (e.g., the same or different asset) to Person 1 in exchange. In certain embodiments, Person 1 wants to access an identification (e.g., of Person 2) that is controlled by an asset control node.

Referring still to FIG. 7, the transaction is then broadcast to one or more of the transaction nodes registered with the asset control node that controls the asset being exchanged within the system. In certain embodiments, a transaction involves only one transaction node, while in certain embodiments, a transaction involves multiple transaction nodes (e.g., one per party to the transaction). In certain embodiments, a transaction node comprises a transaction module for receiving requests (e.g., from individuals) to process (e.g., by recording) transactions, broadcasting the transactions to a memory pool (e.g., of pending transactions), and verifying transactions in a memory pool (e.g., thereby making them approved transactions). FIG. 7 shows an exemplary embodiment where Person 1 wishes to transact with Person 2 by sending an amount of an asset to Person 2. In the exemplary embodiment, Person 1 indicates to one transaction node that he/she wishes to send the amount of the asset and Person 2 indicates to a distinct transaction node that he/she wishes to receive the amount of the asset. In certain embodiments, a transaction can proceed with less than all parties involved indicating their intention. For example, Person 1 can send an amount of an asset to Person 2 without explicit consent of Person 2 (or knowledge of the intended transaction). In any case, standard nodes (e.g., as shown in FIG. 7) can mine to record transactions on a blockchain, but cannot participate in facilitating the transactions.

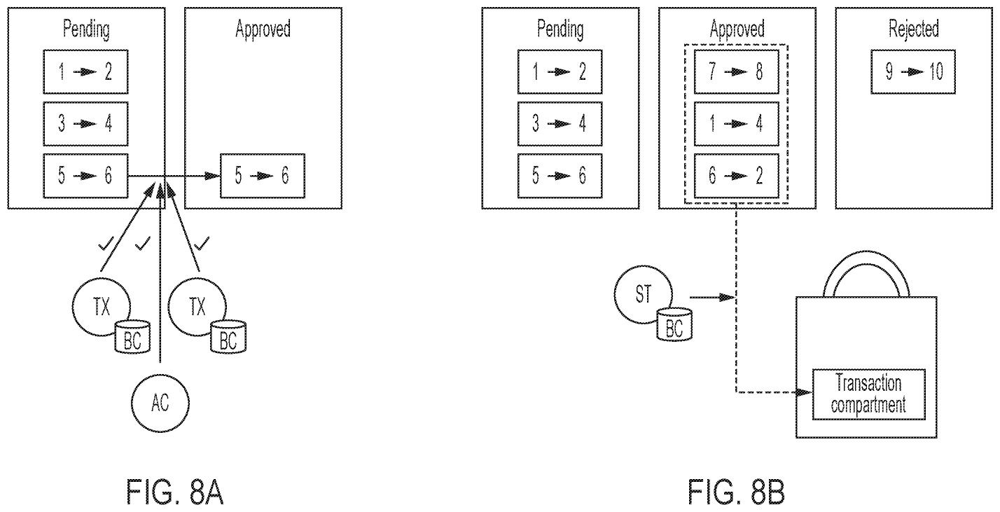

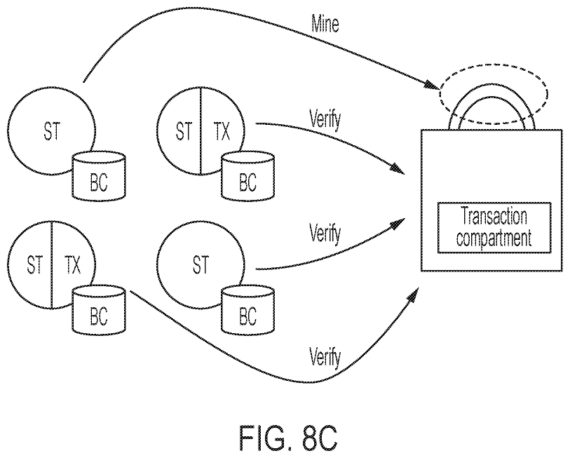

FIGS. 8A-8C are diagrams that show an exemplary process of adding transactions to a blockchain. In certain embodiments, as shown in FIG. 8A, a list of pending transactions is kept. Pending transaction may be those broadcast by one or more nodes based on input received from users (e.g., Person 1 and Person 2 in the example of FIG. 7). In the exemplary embodiment shown in FIG. 8A, transactions must be approved prior to being recorded. Pending transactions that are approved are moved to a list of approved transactions that can then be recorded on a blockchain. In certain embodiments, and as shown in FIG. 8A, a transaction must be approved by each transaction node involved in the transaction as well as each asset control node for the asset(s) being used in the transaction. FIG. 8A shows that Person 5 is sending an amount of a single asset to Person 6 using two separate transaction nodes. Therefore, in this example, the transaction must be approved by both transaction nodes and the asset control node for the single asset prior to being moved to the approved list.

Approving a transaction may require at least one or both of verifying the identity of the persons involved in the transaction and verifying that any assets being sent from one person to another are indeed owned by the respective sender. In certain embodiments, each transaction node and asset control node involved in approving a transaction node amends the transaction data for a transaction to include it digital signature as part of the approval process. In certain embodiments, an issue with transaction data written as part of a transaction may cause one or more approving parties (e.g., transaction node(s) and/or asset control node(s)) to reject the transaction, in which case it may be moved to a rejected transaction list. The process of forming pending transactions and/or approving pending transactions may be referred to as “writing transaction data”.

FIG. 8B shows a list of pending transactions, approved transactions, and rejected transactions. There are three approved transactions. The approved transactions can be used by a node to create a transaction compartment in an outer block (e.g., that does or does not comprise an asset control compartment). In certain embodiments, any node (e.g., a standard node or transaction node) can create a transaction compartment that includes transactions on the approved transaction list. In certain embodiments, transaction data (e.g., corresponding to pending transactions, approved transactions, and/or rejected transactions) is stored in a memory pool accessible by miners (e.g., standard nodes). In certain embodiments, transactions are left on an approved list until they have been included in a transaction compartment in an outer block that has been mined to a blockchain (e.g., remain within a memory pool until verified to be in a block on the blockchain). In this way, a node creating a new outer block comprising a transaction compartment may check that the transaction data for each transaction has not yet been included in a previous outer block that is part of the blockchain. This eliminate duplicate transactions being recorded on a blockchain, which can have adverse consequences. FIG. 8B, shows a standard node creating a new outer block that comprises a transaction compartment that includes the three approved transactions. If a transaction is rejected one or more of the transaction nodes involved may attempt to rewrite the transaction data and read the transaction to the pending list in order to be assessed for approval again.

FIG. 8C shows that the new outer block created in FIG. 8B is then mined by the standard node. In certain embodiments, a transaction node can similarly create and mine outer blocks. In the exemplary embodiment shown in FIG. 8C, three nodes verify the new outer block after it is mined. Two of the nodes are transaction nodes and one is a standard node.

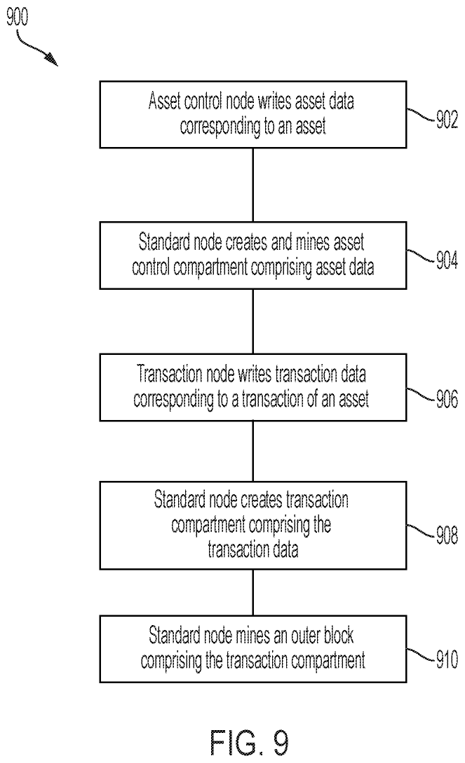

FIG. 9 is a flow diagram of an exemplary method of using a system disclosed herein. In step 902, an asset control node (e.g., a node permissioned to be an asset control node by an assessor node) writes asset data. In certain embodiments, the asset control node broadcasts the asset data to a memory pool. In step 904, a standard node creates and mines an asset control compartment that comprises the asset data. In certain embodiments, the asset control compartment comprises a validation string after it has been mined. In certain embodiments, the standard node then broadcasts the asset control compartment to other nodes within the system for inclusion in a new outer block. In certain embodiments, after mining, the standard node then creates a new outer block comprising the asset control compartment and mines the new outer block. In step 906, a transaction node (e.g., the standard node) writes transaction data corresponding to a transaction of the asset. In certain embodiments, the transaction node broadcasts the transaction data to a memory pool. In step 908, a standard node creates a transaction compartment comprising the transaction data. In step 910, a standard node mines an outer block comprising the transaction data. The standard node in steps 904, 908, and 910 can be the same or different from the standard node in any of the other of steps 904, 908, and 910.

In certain embodiments, a system uses a proprietary coin to handle all system-level transactions within the system (e.g., mining rewards, asset data writing, and asset control node registration). For example, one or more of the following may be true in a system: mining rewards may be paid in a proprietary coin, fees for writing asset data may be required to be paid in the proprietary coin, and fees for registering as an asset control node (e.g., with an assessor node) may be required to be paid in the proprietary coin. In certain embodiments, a proprietary coin is transacted and/or controlled as described above. A super node or node controlled by a super node may act as the asset control node for a proprietary coin. A portion of the coin in a system may be held in a revenue pool and distributed periodically as a dividend to coin holders once one or more certain conditions are met. In this way, a proprietary coin can have value as an asset similar, at least in certain regards, to equity shares in a company (e.g., such that a steady exchange rate (share price) exists between the proprietary coin and one or more currencies). In certain embodiments, the amount of proprietary coin within a system is set initially to some fixed amount. In certain embodiments, the amount of proprietary coin within a system grows over time.

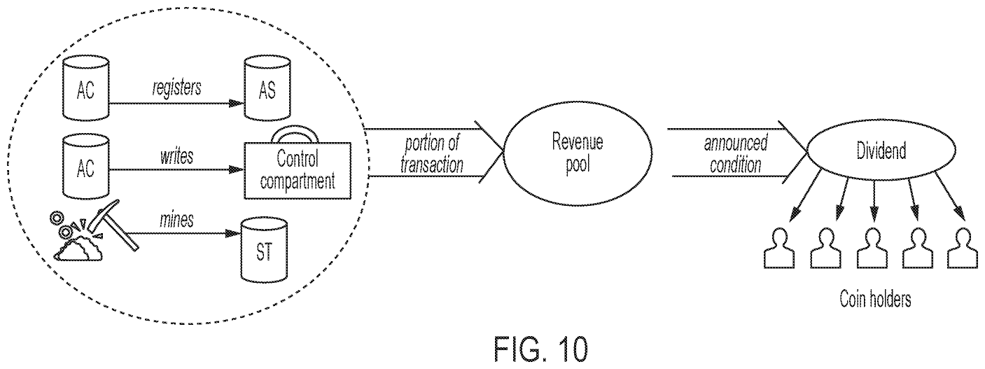

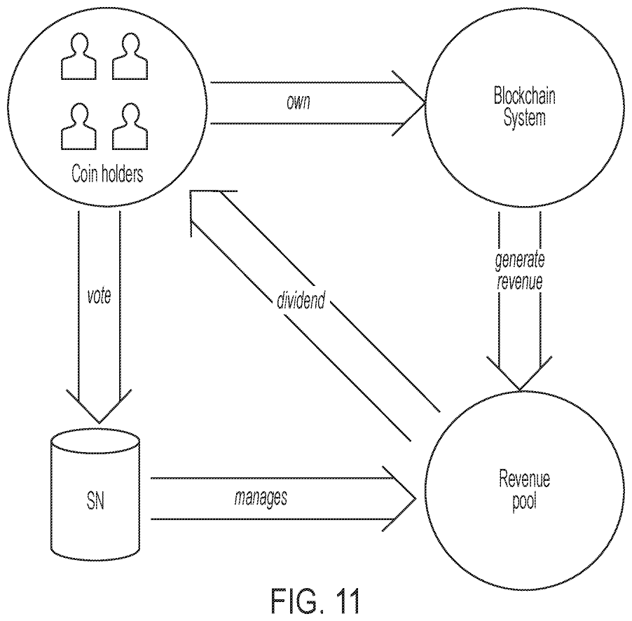

FIG. 10 is a diagram of relationships for a blockchain to generate and distribute revenue. A proprietary coin may be used to do so. As shown in FIG. 10, in an exemplary system, fees are paid for nodes to register with an assessor node as asset control nodes as well as for asset control nodes to write asset data to be stored in an asset control compartment and a mining reward is given to any node (e.g., standard node) that mines an outer block or asset control compartment. A portion of each of these fees/rewards is sent to a revenue pool (e.g., recorded as a transaction received by a revenue pool) for the system. The revenue pool therefore grows over time as more activity takes place within the system. There are then one or more conditions that determine when a dividend is paid out of a revenue pool to coin holders (e.g., similarly to a dividend is paid to shareholders of an equity such as a stock). One or more conditions for paying a dividend may be based, at least in part, on an amount of coin in a revenue pool and/or a number of payments into the revenue pool since the last dividend, for example.

FIG. 11 is a diagram of an exemplary system showing relationships between coin holders, the exemplary system, a super node and a revenue pool. The coin holders own the blockchain system, where the amount of proprietary coin owned by each coin holder represents his or her proportional share of the system. The blockchain system generates revenue (e.g., as described above) as activity takes place within the system, which is directed to the revenue pool. The revenue pool is used to pay dividends to the coin holders. The coin holders also vote on the super node. The super node oversees the system, manages the revenue pool, and, in this example, appoints assessor nodes.

Certain aspects of a system may be codified in a smart contract stored on the system. For example, rules governing fees and/or rewards may be part of a smart contract. Rules governing assessor nodes, such as how much coin they must hold in an escrow-type reserve in case of bad faith action by an asset control node that they assess, may be governed by a smart contract. In certain embodiments, a super node is permissioned to modify such a smart contract (e.g., acts as an asset control node for the smart contract). In certain embodiments, an asset control node may record a smart contract to a blockchain that controls aspects of how transactions for the asset controlled by the node are processed and/or recorded. For example, in certain embodiments, an asset control node may record a smart contract that requires that a transaction node for the asset controlled by the asset control node pay a fee to record a transaction of the asset. Such smart contracts may improve trust in a system by increasing transparency, since all nodes can access (e.g., read) changes made a governing smart contract.

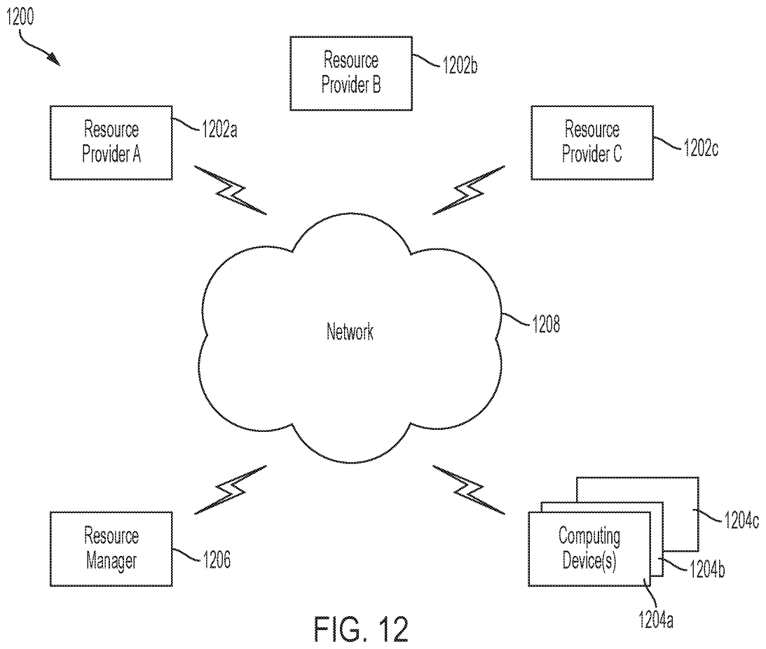

Exemplary embodiments of systems and methods disclosed herein were described above with reference to computations performed locally by a computing device. However, computations performed over a network are also contemplated. FIG. 12 shows an illustrative network environment 1200 for use in the methods and systems described herein. In brief overview, referring now to FIG. 12, a block diagram of an exemplary cloud computing environment 1200 is shown and described. The cloud computing environment 1200 may include one or more resource providers 1202a, 1202b, 1202c (collectively, 1202). Each resource provider 1202 may include computing resources. In some implementations, computing resources may include any hardware and/or software used to process data. For example, computing resources may include hardware and/or software capable of executing algorithms, computer programs, and/or computer applications. In some implementations, exemplary computing resources may include application servers and/or databases with storage and retrieval capabilities. Each resource provider 1202 may be connected to any other resource provider 1202 in the cloud computing environment 1200. In some implementations, the resource providers 1202 may be connected over a computer network 1208. Each resource provider 1202 may be connected to one or more computing device 1204a, 1204b, 1204c (collectively, 1204), over the computer network 1208.

The cloud computing environment 1200 may include a resource manager 1206. The resource manager 1206 may be connected to the resource providers 1202 and the computing devices 1204 over the computer network 1208. In some implementations, the resource manager 1206 may facilitate the provision of computing resources by one or more resource providers 1202 to one or more computing devices 1204. The resource manager 1206 may receive a request for a computing resource from a particular computing device 1204. The resource manager 1206 may identify one or more resource providers 1202 capable of providing the computing resource requested by the computing device 1204. The resource manager 1206 may select a resource provider 1202 to provide the computing resource. The resource manager 1206 may facilitate a connection between the resource provider 1202 and a particular computing device 1204. In some implementations, the resource manager 1206 may establish a connection between a particular resource provider 1202 and a particular computing device 1204. In some implementations, the resource manager 1206 may redirect a particular computing device 1204 to a particular resource provider 1202 with the requested computing resource.

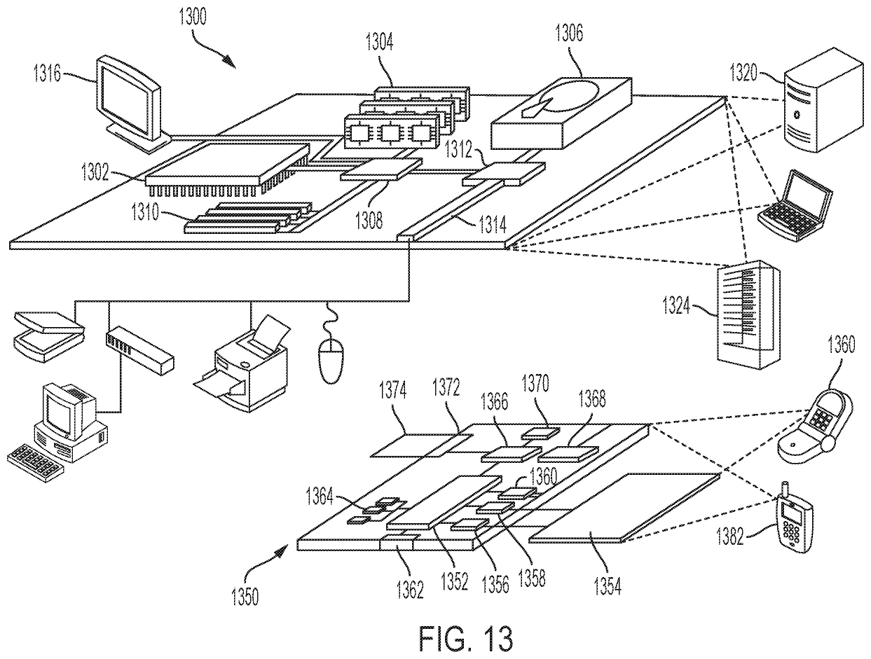

FIG. 13 shows an example of a computing device 1300 and a mobile computing device 1350 that can be used in the methods and systems described in this disclosure. The computing device 1300 is intended to represent various forms of digital computers, such as laptops, desktops, workstations, personal digital assistants, servers, blade servers, mainframes, and other appropriate computers. The mobile computing device 1350 is intended to represent various forms of mobile devices, such as personal digital assistants, cellular telephones, smart-phones, and other similar computing devices. The components shown here, their connections and relationships, and their functions, are meant to be examples only, and are not meant to be limiting.

The computing device 1300 includes a processor 1302, a memory 1304, a storage device 1306, a high-speed interface 1308 connecting to the memory 1304 and multiple high-speed expansion ports 1310, and a low-speed interface 1312 connecting to a low-speed expansion port 1314 and the storage device 1306. Each of the processor 1302, the memory 1304, the storage device 1306, the high-speed interface 1308, the high-speed expansion ports 1310, and the low-speed interface 1312, are interconnected using various busses, and may be mounted on a common motherboard or in other manners as appropriate. The processor 1302 can process instructions for execution within the computing device 1300, including instructions stored in the memory 1304 or on the storage device 1306 to display graphical information for a GUI on an external input/output device, such as a display 1316 coupled to the high-speed interface 1308. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system). Also, multiple computing devices may be connected, with each device providing portions of the necessary operations (e.g., as a server bank, a group of blade servers, or a multi-processor system). Thus, as the term is used herein, where a plurality of functions are described as being performed by “a processor”, this encompasses embodiments wherein the plurality of functions are performed by any number of processors (e.g., one or more processors) of any number of computing devices (e.g., one or more computing devices). Furthermore, where a function is described as being performed by “a processor”, this encompasses embodiments wherein the function is performed by any number of processors (e.g., one or more processors) of any number of computing devices (e.g., one or more computing devices) (e.g., in a distributed computing system).

The memory 1304 stores information within the computing device 1300. In some implementations, the memory 1304 is a volatile memory unit or units. In some implementations, the memory 1304 is a non-volatile memory unit or units. The memory 1304 may also be another form of computer-readable medium, such as a magnetic or optical disk.

The storage device 1306 is capable of providing mass storage for the computing device 1300. In some implementations, the storage device 1306 may be or contain a computer-readable medium, such as a floppy disk device, a hard disk device, an optical disk device, or a tape device, a flash memory or other similar solid state memory device, or an array of devices, including devices in a storage area network or other configurations. Instructions can be stored in an information carrier. The instructions, when executed by one or more processing devices (for example, processor 1302), perform one or more methods, such as those described above. The instructions can also be stored by one or more storage devices such as computer- or machine-readable mediums (for example, the memory 1304, the storage device 1306, or memory on the processor 1302).

The high-speed interface 1308 manages bandwidth-intensive operations for the computing device 1300, while the low-speed interface 1312 manages lower bandwidth-intensive operations. Such allocation of functions is an example only. In some implementations, the high-speed interface 1308 is coupled to the memory 1304, the display 1316 (e.g., through a graphics processor or accelerator), and to the high-speed expansion ports 1310, which may accept various expansion cards (not shown). In the implementation, the low-speed interface 1312 is coupled to the storage device 1306 and the low-speed expansion port 1314. The low-speed expansion port 1314, which may include various communication ports (e.g., USB, Bluetooth®, Ethernet, wireless Ethernet) may be coupled to one or more input/output devices, such as a keyboard, a pointing device, a scanner, or a networking device such as a switch or router, e.g., through a network adapter.

The computing device 1300 may be implemented in a number of different forms, as shown in the figure. For example, it may be implemented as a standard server 1320, or multiple times in a group of such servers. In addition, it may be implemented in a personal computer such as a laptop computer 1322. It may also be implemented as part of a rack server system 1324. Alternatively, components from the computing device 1300 may be combined with other components in a mobile device (not shown), such as a mobile computing device 1350. Each of such devices may contain one or more of the computing device 1300 and the mobile computing device 1350, and an entire system may be made up of multiple computing devices communicating with each other.

The mobile computing device 1350 includes a processor 1352, a memory 1364, an input/output device such as a display 1354, a communication interface 1366, and a transceiver 1368, among other components. The mobile computing device 1350 may also be provided with a storage device, such as a micro-drive or other device, to provide additional storage. Each of the processor 1352, the memory 1364, the display 1354, the communication interface 1366, and the transceiver 1368, are interconnected using various buses, and several of the components may be mounted on a common motherboard or in other manners as appropriate.

The processor 1352 can execute instructions within the mobile computing device 1350, including instructions stored in the memory 1364. The processor 1352 may be implemented as a chipset of chips that include separate and multiple analog and digital processors. The processor 1352 may provide, for example, for coordination of the other components of the mobile computing device 1350, such as control of user interfaces, applications run by the mobile computing device 1350, and wireless communication by the mobile computing device 1350.

The processor 1352 may communicate with a user through a control interface 1358 and a display interface 1356 coupled to the display 1354. The display 1354 may be, for example, a TFT (Thin-Film-Transistor Liquid Crystal Display) display or an OLED (Organic Light Emitting Diode) display, or other appropriate display technology. The display interface 1356 may comprise appropriate circuitry for driving the display 1354 to present graphical and other information to a user. The control interface 1358 may receive commands from a user and convert them for submission to the processor 1352. In addition, an external interface 1362 may provide communication with the processor 1352, so as to enable near area communication of the mobile computing device 1350 with other devices. The external interface 1362 may provide, for example, for wired communication in some implementations, or for wireless communication in other implementations, and multiple interfaces may also be used.

The memory 1364 stores information within the mobile computing device 1350. The memory 1364 can be implemented as one or more of a computer-readable medium or media, a volatile memory unit or units, or a non-volatile memory unit or units. An expansion memory 1374 may also be provided and connected to the mobile computing device 1350 through an expansion interface 1372, which may include, for example, a SIMM (Single In Line Memory Module) card interface. The expansion memory 1374 may provide extra storage space for the mobile computing device 1350, or may also store applications or other information for the mobile computing device 1350. Specifically, the expansion memory 1374 may include instructions to carry out or supplement the processes described above, and may include secure information also. Thus, for example, the expansion memory 1374 may be provided as a security module for the mobile computing device 1350, and may be programmed with instructions that permit secure use of the mobile computing device 1350. In addition, secure applications may be provided via the SIMM cards, along with additional information, such as placing identifying information on the SIMM card in a non-hackable manner.

The memory may include, for example, flash memory and/or NVRAM memory (non-volatile random access memory), as discussed below. In some implementations, instructions are stored in an information carrier and, when executed by one or more processing devices (for example, processor 1352), perform one or more methods, such as those described above. The instructions can also be stored by one or more storage devices, such as one or more computer- or machine-readable mediums (for example, the memory 1364, the expansion memory 1374, or memory on the processor 1352). In some implementations, the instructions can be received in a propagated signal, for example, over the transceiver 1368 or the external interface 1362.

The mobile computing device 1350 may communicate wirelessly through the communication interface 1366, which may include digital signal processing circuitry where necessary. The communication interface 1366 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 1368 using a radio-frequency. In addition, short-range communication may occur, such as using a Bluetooth®, Wi-Fi™, or other such transceiver (not shown). In addition, a GPS (Global Positioning System) receiver module 1370 may provide additional navigation- and location-related wireless data to the mobile computing device 1350, which may be used as appropriate by applications running on the mobile computing device 1350.

The mobile computing device 1350 may also communicate audibly using an audio codec 1360, which may receive spoken information from a user and convert it to usable digital information. The audio codec 1360 may likewise generate audible sound for a user, such as through a speaker, e.g., in a handset of the mobile computing device 1350. Such sound may include sound from voice telephone calls, may include recorded sound (e.g., voice messages, music files, etc.) and may also include sound generated by applications operating on the mobile computing device 1350.

The mobile computing device 1350 may be implemented in a number of different forms, as shown in the figure. For example, it may be implemented as a cellular telephone 1380. It may also be implemented as part of a smart-phone 1382, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

Certain embodiments of the present disclosure were expressly described above. It is, however, expressly noted that the present disclosure is not limited to those embodiments, but rather the intention is that additions and modifications to what was expressly described herein are also included within the scope of the disclosure. Moreover, it is to be understood that the features of the various embodiments described herein were not mutually exclusive and can exist in various combinations and permutations, even if such combinations or permutations were not made express herein, without departing from the spirit and scope of the disclosure. In fact, variations, modifications, and other implementations of what was described herein will occur to those of ordinary skill in the art without departing from the spirit and the scope of the disclosure. As such, the disclosure is not to be defined only by the preceding illustrative description.

Having described certain implementations of methods and apparatus for recording multiple assets in a blockchain it will now become apparent to one of skill in the art that other implementations incorporating the concepts of the disclosure may be used. Therefore, the disclosure should not be limited to certain implementations, but rather should be limited only by the spirit and scope of the following claims.

What is claimed is:

1. A method of storing data (e.g., corresponding to assets and transactions with the assets) in a blockchain, the method comprising:
receiving, by a processor of a computing device (e.g., node), an asset control compartment comprising (i) asset data [e.g., corresponding to one or more assets (e.g., currency, inventory, or identities)] and, optionally, (ii) an asset control validation string (e.g., based, at least in part, on the asset data in the asset control compartment) and a transaction compartment comprising transaction data [e.g., corresponding to one or more transactions and/or authorizations of access (e.g., of and/or to the one or more assets, respectively)];
creating, by the processor of the computing device, a new outer block comprising the asset control compartment and the transaction compartment;
determining, by the processor of the computing device, a hash based, at least in part, on the asset control compartment (e.g., the asset data and, if present, the asset control validation string) and the transaction compartment (e.g., the transaction data);
modifying (e.g., writing to), by the processor of the computing device, the new outer block such that the new outer block comprises the hash; and
optionally, storing, by the processor of the computing device, the new outer block on a non-transitory computer readable medium (e.g., in the blockchain).

2. The method of claim 1, comprising:
determining, by the processor of the computing device, the hash based, at least in part, on a digital signature corresponding to the computing device.

3. The method of claim 1 or claim 2, comprising:
determining, by the processor of the computing device, the hash based, at least in part, on one or more previously mined outer blocks (e.g., one previously mined outer block) [e.g., determining the hash based, at least in part, on a preceding outer block, wherein the preceding outer block immediately precedes the new outer block in an ordered sequence of blocks on the blockchain (e.g., is a most recent block on the blockchain)].

4. The method of claim 3, wherein the one or more previously mined outer blocks each comprise verification data comprising one or more digital signatures (e.g., received from one or more verifying nodes) such that the hash is determined based, at least in part, on the verification data.

5. The method of claim 3 or claim 4, wherein at least one of the one or more previously mined outer blocks corresponds to a block that does not comprise an asset control compartment (e.g., and does comprise a transaction compartment).

6. The method of any one of claims 3-5, wherein each of the one or more previously mined outer blocks comprises a previously mined outer block hash that has been determined based, at least in part, on one or more other previously mined outer blocks.

7. The method of any one of the preceding claims, wherein the asset control validation string is based, at least in part, on one or more established asset control validation strings corresponding to one or more previously mined asset control compartments, wherein each of the one or more earlier asset control compartments comprises one (e.g., only one) of the one or more established asset control validation strings.

8. The method of any one of the preceding claims, comprising:
receiving, by the processor of the computing device, verification data comprising one or more digital signatures corresponding to one or more nodes that have validated the new outer block; and
modifying, by the processor of the computing device, the new outer block to comprise the verification data (e.g., in a header of the new outer block).

9. The method of any one of the preceding claims, wherein the transaction data corresponds to one or more transactions that have been approved for recordation on the blockchain (e.g., by at least one transaction node and an asset control node).

10. The method of any one of the preceding claims, comprising:
receiving, by the processor of the computing device, the transaction data (e.g., from a list of approved transactions); and
creating, by the processor of the computing device, the transaction compartment such that the transaction compartment comprises the transaction data.

11. The method of any one of the preceding claims, wherein the transaction data corresponds to at least one of (i) one or more exchanges of at least one asset (e.g., a currency or inventory) and (ii) an authorization to access at least one asset (e.g., an identification) (e.g., wherein the asset is one of the one or more assets corresponding to the asset data).

12. The method of any one of the preceding claims, wherein (i) at least a portion of the asset data is identification data corresponding to one or more personal identities, (ii) at least a portion of the transaction data corresponds to one or more authorizations to access, records of access, or verifications of identification data, or (iii) both (i) and (ii).

13. The method of any one of the preceding claims, wherein the asset data corresponds to at least one of creation, update (e.g., modification), regulation, and deletion of one or more assets (e.g., currency, inventory, or identities).

14. The method of any one of the preceding claims, wherein the asset data has been provided by an asset control node.

15. The method of any one of the preceding claims, comprising:
broadcasting, by the processor of the computing device, over a network to a plurality of computing devices (e.g., a plurality of nodes), the new outer block after the modifying step.

16. The method of any one of the preceding claims, wherein the blockchain is a public blockchain.

17. A system for storing data (e.g., corresponding to assets and transactions with the assets) in a blockchain, the system comprising:
a processor (e.g., wherein a node comprises the processor); and
a non-transitory computer readable medium (e.g., memory) having instructions stored thereon, wherein the instructions, when executed by the processor, cause the processor to:
receive an asset control compartment comprising (i) asset data [e.g., corresponding to one or more assets (e.g., currency, inventory, or identities)] and, optionally, (ii) an asset control validation string (e.g., based, at least in part, on the asset data in the asset control compartment) and a transaction compartment comprising transaction data [e.g., corresponding to one or more transactions and/or authorizations of access (e.g., of and/or to the one or more assets, respectively)];
create a new outer block comprising the asset control compartment and the transaction compartment;
determine a hash based, at least in part, on the asset control compartment (e.g., the asset data and, if present, the asset control validation string) and the transaction compartment (e.g., the transaction data);
modify (e.g., write to) the new outer block such that the new outer block comprises the hash; and
optionally, store the new outer block on a (e.g., the) non-transitory computer readable medium (e.g., in the blockchain).

18. The system of claim 17, wherein the instructions, when executed by the processor, cause the processor to:
determine the hash based, at least in part, on a digital signature corresponding to the computing device.

19. The system of claim 17 or claim 18, wherein the instructions, when executed by the processor, cause the processor to:
determine the hash based, at least in part, on one or more previously mined outer blocks (e.g., one previously mined outer block) [e.g., determining the hash based, at least in part, on a preceding outer block, wherein the preceding outer block immediately precedes the new outer block in an ordered sequence of blocks on the blockchain (e.g., is a most recent block on the blockchain)].

20. The system of claim 19, wherein the one or more previously mined outer blocks each comprise verification data comprising one or more digital signatures (e.g., received from one or more verifying nodes) such that the hash is determined based, at least in part, on the verification data.

21. The system of claim 19 or claim 20, wherein at least one of the one or more previously mined outer blocks corresponds to a block that does not comprise an asset control compartment (e.g., and does comprise a transaction compartment).

22. The system of any one of claims 19-21, wherein each of the one or more previously mined outer blocks comprises a previously mined outer block hash that has been determined based, at least in part, on one or more other previously mined outer blocks.

23. The system of any one of claims 17-22, wherein the asset control validation string is based, at least in part, on one or more established asset control validation strings corresponding to one or more previously mined asset control compartments, wherein each of the one or more earlier asset control compartments comprises one (e.g., only one) of the one or more established asset control validation strings.

24. The system of any one of claims 17-23, wherein the instructions, when executed by the processor, cause the processor to:
receive verification data comprising one or more digital signatures corresponding to one or more nodes that have validated the new outer block (e.g., by validating the hash and/or data on which the hash is based); and
modify the new outer block to comprise the verification data (e.g., in a header of the new outer block).

25. The system of any one claims 17-24, wherein the transaction data corresponds to one or more transactions that have been approved for recordation on the blockchain (e.g., by at least one transaction node and an asset control node).

26. The system of any one of claims 17-25, wherein the instructions, when executed by the processor, cause the processor to:
receive the transaction data (e.g., from a list of approved transactions); and
create the transaction compartment such that the transaction compartment comprises the transaction data.

27. The system of any one of claims 17-26, wherein the transaction data corresponds to at least one of (i) one or more exchanges of at least one asset (e.g., a currency or inventory) and (ii) an authorization to access at least one asset (e.g., an identification) (e.g., wherein the asset is one of the one or more assets corresponding to the asset data).

28. The system of any one of claims 17-27, wherein (i) at least a portion of the asset data is identification data corresponding to one or more personal identities, (ii) at least a portion of the transaction data corresponds to one or more authorizations to access, records of access, or verifications of identification data, or (iii) both (i) and (ii).

29. The system of any one of claims 17-28, wherein the asset data corresponds to at least one of creation, update (e.g., modification), regulation, and deletion of one or more assets (e.g., currency, inventory, or identities).

30. The system of any one of claims 17-29, wherein the asset data has been provided by an asset control node.

31. The system of any one of claims 17-30, wherein the instructions, when executed by the processor, cause the processor to:
broadcast, over a network to a plurality of computing devices (e.g., a plurality of nodes), the new outer block after the modifying step.

32. The system of any one of claims 17-31, wherein the blockchain is a public blockchain.

33. A system for storing multi-asset data in a blockchain, the system comprising:
an outer block comprising a hash;
an asset control compartment comprising (i) asset data [e.g., corresponding to one or more assets (e.g., currency, inventory, or identities)] and, optionally, (ii) an asset control validation string (e.g., a cryptographic hash satisfying one or more validation conditions) (e.g., based, at least in part, on the asset data in the asset control compartment); and
a transaction compartment comprising transaction data [e.g., corresponding to one or more transactions and/or authorizations of access (e.g., of and/or to the one or more assets)],
wherein the outer block comprises the asset control compartment and the transaction compartment and the hash is based, at least in part, on the asset control compartment (e.g., the asset data and, if present, the asset control validation string) and the transaction compartment (e.g., the transaction data).

34. The system of claim 33, wherein the hash is based, at least in part, on one or more previously mined outer blocks [e.g., determining the hash based, at least in part, on a preceding outer block, wherein the preceding outer block immediately precedes the new outer block in an ordered sequence of blocks on the blockchain (e.g., is a most recent block on the blockchain)].

35. The system of claim 34, wherein the one or more previously mined outer blocks each comprise verification data comprising one or more digital signatures (e.g., received from one or more verifying nodes) such that the hash is determined based, at least in part, on the verification data.

36. The system of claim 34 or claim 35, wherein at least one (e.g., only one) of the one or more previously mined outer blocks corresponds to a block that does not comprise an asset control compartment (e.g., and does comprise a transaction compartment).

37. The system of any one of claims 34-36, wherein each of the one or more previously mined outer blocks comprises a previously mined outer block hash that has been determined based, at least in part, on one or more other previously mined outer blocks.

38. The system of any one of claims 33-37, wherein the asset control validation string is based, at least in part, on one or more established asset control validation strings corresponding to one or more mined asset control compartments, wherein each of the one or more earlier asset control compartments comprises one (e.g., only one) of the one or more established asset control validation strings.

39. The system of any one of claims 33-38, wherein the transaction data corresponds to one or more transactions that have been approved for recordation on the blockchain [e.g., approved (e.g., verified) by at least one transaction node and an asset control node].

40. The system of any one of claims 33-39, wherein the transaction data corresponds to at least one of (i) one or more exchanges of at least one asset (e.g., a currency or inventory) and (ii) an authorization to access at least one asset (e.g., an identification) (e.g., wherein the asset is one of the one or more assets corresponding to the asset data).

41. The system of any one of claims 33-40, wherein (i) at least a portion of the asset data is identification data corresponding to one or more personal identities, (ii) at least a portion of the transaction data corresponds to one or more authorizations to access, records of access, or verifications of identification data, or (iii) both (i) and (ii).

42. The system of any one of claims 33-41, wherein the asset data corresponds to at least one of creation, update (e.g., modification), regulation, and deletion of one or more assets (e.g., currency, inventory, or identities).

43. The system of any one of claims 33-42, wherein the asset data has been provided by an asset control node.

44. The system of any one of claims 33-43, wherein the blockchain is a public blockchain.

45. A method for recording data in a blockchain with increased security, the method comprising:
receiving, by a processor of a computing device, at least a portion of a previously mined outer block [e.g., a previously mined outer block or a hash (e.g., validation string) of a previously mined outer block] and at least a portion of a previously mined inner block [e.g., the previously mined inner block or a hash (e.g., validation string) of the previously mined inner block], wherein the previously mined inner block is recorded on the blockchain;
creating, by the processor of the computing device, a new inner block;
determining, by the processor of the computing device, a new inner block hash (e.g., a new inner block validation string) based, at least in part, on the at least a portion of a previously mined outer block and the at least a portion of the previously mined inner block;
modifying (e.g., writing to), by the processor of the computing device, the new inner block such that the new inner block comprises the new inner block hash; and
optionally, storing, by the processor of the computing device, the new inner block on a non-transitory computer readable medium (e.g., in the blockchain).

46. The method of claim 45, wherein the creating step comprises:
receiving, by the processor of the computing device, block data; and
modifying, by the processor of the computing device, the new inner block to comprise the block data.

47. The method of claim 45 or claim 46, wherein the at least a portion of a previously mined outer block comprises a hash (e.g., a validation string) of the previously mined outer block.

48. The method of any one of claims 45-47, wherein the at least a portion of a previously mined inner block comprises a validation string of the previously mined inner block.

49. The method of any one of claims 45-48, wherein the new inner block hash comprises a new inner block validation string.

50. The method of any one of claims 45-49, comprising:
creating, by the processor of the computing device, a new outer block comprising the new inner block comprising the new inner block hash (e.g., after the modification step);
determining, by the processor of the computing device, a new outer block hash based, at least in part, on the new inner block;
modifying (e.g., writing to), by the processor of the computing device, the new outer block such that the new outer block comprises the new outer block hash; and
optionally, storing, by the processor of the computing device, the new outer block on a non-transitory computer readable medium.

51. The method of claim 50, wherein the new outer block comprises outer block data (e.g., stored in a compartment) separate from the new inner block.

52. The method of any one of claims 45-51, comprising:
broadcasting, by the processor of the computing device, over a network to a plurality of computing devices (e.g., a plurality of nodes), the new outer block after the modifying step.

53. The method of any one of claims 45-52, wherein the blockchain is a public blockchain.

54. The method of any one of claims 45-52, wherein the blockchain is a private blockchain.

55. A system for recording data in a blockchain with increased security, the system comprising:
a processor (e.g., wherein a node comprises the processor); and
a non-transitory computer readable medium (e.g., memory) having instructions stored thereon, wherein the instructions, when executed by the processor, cause the processor to:
receive at least a portion of a previously mined outer block [e.g., a previously mined outer block or a hash (e.g., validation string) of a previously mined outer block] and at least a portion of a previously mined inner block [e.g., the previously mined inner block or a hash (e.g., validation string) of the previously mined inner block], wherein the previously mined inner block is recorded on the blockchain;
create a new inner block;
determine a new inner block hash (e.g., a new inner block validation string) based, at least in part, on the at least a portion of a previously mined outer block and the at least a portion of the previously mined inner block;
modify (e.g., write to) the new inner block such that the new inner block comprises the new inner block hash; and
optionally, store the new inner block on a (e.g., the) non-transitory computer readable medium (e.g., in the blockchain).

56. The system of claim 55, wherein the instructions, when executed by the processor, cause the processor to create the new block, at least in part, by:
receiving, by the processor, block data; and
modifying, by the processor, the new inner block to comprise the block data.

57. The system of claim 55 or claim 56, wherein the at least a portion of a previously mined outer block is a hash (e.g., a validation string) of the previously mined outer block.

58. The system of any one of claims 55-57, wherein the at least a portion of a previously mined inner block comprises a validation string of the previously mined inner block.

59. The system of any one of claims 55-58, wherein the new inner block hash comprises a new inner block validation string.

60. The system of any one of claims 55-59, wherein the instructions, when executed by the processor, cause the processor to:
create a new outer block comprising the new inner block comprising the new inner block hash (e.g., after the modification step);
determine a new outer block hash based, at least in part, on the new inner block;
modify (e.g., write to) the new outer block such that the new outer block comprises the new outer block hash; and
optionally, store the new outer block on a (e.g., the) non-transitory computer readable medium.

61. The system of claim 60, wherein the new outer block comprises outer block data (e.g., stored in a compartment) separate from the new inner block.

62. The system of any one of claims 55-61, wherein the instructions, when executed by the processor, cause the processor to:
broadcast, over a network to a plurality of computing devices (e.g., a plurality of nodes), the new outer block after the modifying step.

63. The method of any one of claims 55-62, wherein the blockchain is a public blockchain.

64. The method of any one of claims 55-62, wherein the blockchain is a private blockchain.

65. A method of being rewarded for adding a block to a blockchain by determining a hash [e.g., a block validation string (e.g., a cryptographic hash satisfying one or more validation conditions) (e.g., demonstrating proof of work)], the method comprising:
creating, by a processor of a computing device (e.g., a node), the block comprising block data to be added to the blockchain, wherein the block data comprises mining reward data, wherein the mining rewards data corresponds to a mining reward (e.g., amount of currency or coin) and the mining reward has been determined based, at least in part, on at least one of (i) an amount of time that has elapsed and (ii) a number of blocks that have been added to the blockchain since the computing device previously added (e.g., mined) a block to the blockchain (e.g., such that an operator of the computing device received a prior mining reward);
determining, by the processor of the computing device, the hash (e.g., wherein the ash is block validation string) based, at least in part, on the block data;
modifying, by the processor of the computing device, the block to comprise the hash;
optionally, storing, by the processor of the computing device, the block on a non-transitory computer readable medium; and
optionally, broadcasting, by the processor of the computing device, over a network to a plurality of nodes, the block.

66. The method of claim 65, wherein the mining reward has been determined, at least in part, by a function dependent on the amount of time that has elapsed since the computing device previously added the block to the blockchain (e.g., wherein the amount of time is an input to a step function, an error function, linear function, or asymptotic function that determines the mining reward).

67. The method of claim 65 or claim 66, wherein the mining reward has been determined, at least in part, by a function dependent on the number of blocks that have been added to the blockchain since the computing device previously added the block to the blockchain (e.g., wherein the amount of time is an input to a step function, an error function, linear function, or asymptotic function that determines the mining reward).

68. A method of being rewarded for adding a block to a blockchain by determining a hash [e.g., a block validation string (e.g., a cryptographic hash satisfying one or more validation conditions) (e.g., demonstrating proof of work)], the method comprising:
creating, by a processor of a computing device (e.g., a node), the block;
determining, by the processor of the computing device, the hash based, at least in part, on the block data;
modifying, by the processor of the computing device, the block to comprise the hash;
creating, by the processor of the computing device, transaction data, wherein the transaction data comprises mining reward data, wherein the mining rewards data corresponds to a mining reward (e.g., amount of currency or coin) and the mining reward has been determined based, at least in part, on at least one of (i) an amount of time that has elapsed and (ii) a number of blocks that have been added to the blockchain since the computing device previously added (e.g., mined) a block to the blockchain (e.g., such that an operator of the computing device received a prior mining reward);
optionally, storing, by the processor of the computing device, the block on a non-transitory computer readable medium; and
optionally, broadcasting, by the processor of the computing device, over a network to a plurality of nodes, the block.

69. The method of claim 68, wherein the mining reward has been determined, at least in part, by a function dependent on the amount of time that has elapsed since the computing device previously added the block to the blockchain (e.g., wherein the amount of time is an input to a step function, an error function, linear function, or asymptotic function that determines the mining reward).

70. The method of claim 68 or claim 69, wherein the mining reward has been determined, at least in part, by a function dependent on the number of blocks that have been added to the blockchain since the computing device previously added the block to the blockchain (e.g., wherein the amount of time is an input to a step function, an error function, linear function, or asymptotic function that determines the mining reward).

71. A system for being rewarded for adding a block to a blockchain by determining a hash [e.g., a block validation string (e.g., a cryptographic hash satisfying one or more validation conditions) (e.g., demonstrating proof of work)], the system comprising:
a processor (e.g., wherein a node comprises the processor); and
a non-transitory computer readable medium (e.g., memory) having instructions stored thereon, wherein the instructions, when executed by the processor, cause the processor to:
create the block comprising block data to be added to the blockchain, wherein the block data comprises mining reward data, wherein the mining rewards data corresponds to a mining reward (e.g., amount of currency or coin) and the mining reward has been determined based, at least in part, on at least one of (i) an amount of time that has elapsed and (ii) a number of blocks that have been added to the blockchain since the computing device previously added (e.g., mined) a block to the blockchain (e.g., such that an operator of the computing device received a prior mining reward);
determining, by the processor of the computing device, the hash (e.g., wherein the ash is block validation string) based, at least in part, on the block data;
modifying, by the processor of the computing device, the block to comprise the hash;
optionally, storing, by the processor of the computing device, the block on a non-transitory computer readable medium; and
optionally, broadcasting, by the processor of the computing device, over a network to a plurality of nodes, the block.

72. The system of claim 71, wherein the mining reward has been determined, at least in part, by a function dependent on the amount of time that has elapsed since the computing device previously added the block to the blockchain (e.g., wherein the amount of time is an input to a step function, an error function, linear function, or asymptotic function that determines the mining reward).

73. The system of claim 71 or claim 72, wherein the mining reward has been determined, at least in part, by a function dependent on the number of blocks that have been added to the blockchain since the computing device previously added the block to the blockchain (e.g., wherein the amount of time is an input to a step function, an error function, linear function, or asymptotic function that determines the mining reward).

74. A system for being rewarded for adding a block to a blockchain by determining a hash [e.g., a block validation string (e.g., a cryptographic hash satisfying one or more validation conditions) (e.g., demonstrating proof of work)], the system comprising:
a processor (e.g., wherein a node comprises the processor); and
a non-transitory computer readable medium (e.g., memory) having instructions stored thereon, wherein the instructions, when executed by the processor, cause the processor to:
create the block;
determine the hash based, at least in part, on the block data;
modify the block to comprise the hash;
create transaction data, wherein the transaction data comprises mining reward data, wherein the mining rewards data corresponds to a mining reward (e.g., amount of currency or coin) and the mining reward has been determined based, at least in part, on at least one of (i) an amount of time that has elapsed and (ii) a number of blocks that have been added to the blockchain since the computing device previously added (e.g., mined) a block to the blockchain (e.g., such that an operator of the computing device received a prior mining reward);
optionally, store the block on a non-transitory computer readable medium; and
optionally, broadcast, over a network to a plurality of nodes, the block.

75. The system of claim 74, wherein the mining reward has been determined, at least in part, by a function dependent on the amount of time that has elapsed since the computing device previously added the block to the blockchain (e.g., wherein the amount of time is an input to a step function, an error function, linear function, or asymptotic function that determines the mining reward).

76. The system of claim 74 or claim 75, wherein the mining reward has been determined, at least in part, by a function dependent on the number of blocks that have been added to the blockchain since the computing device previously added the block to the blockchain (e.g., wherein the amount of time is an input to a step function, an error function, linear function, or asymptotic function that determines the mining reward).

77. A system for maintaining a blockchain to record transactions in one or more assets, the system comprising:
an asset control node [e.g., in a network of nodes (e.g., wherein the asset control node is a registered node)] comprising an asset control module, wherein the asset control module is for writing (e.g., creating) asset data to be stored on the blockchain, wherein the asset data corresponds to at least one of creation, update (e.g., modification), regulation, and deletion of an asset (e.g., currency, inventory, or identities).

78. The system of claim 77, wherein the asset control module is also for approving and/or rejecting transaction data (e.g., over the network) (e.g., by validating the transaction data) corresponding to one or more transactions of and/or authorizations of access to the asset.

79. The system of claim 78, wherein the transactions, if approved, are stored in memory pool [e.g., to be included in a transaction compartment in a block on the blockchain by a node (e.g., standard node)].

80. The system of any one of claims 77-79, wherein the blockchain is a public blockchain.

81. The system of any one of claims 77-80, wherein the asset data corresponds to at least one of creation, update (e.g., modification), regulation, and deletion of a plurality of assets (e.g., currency, inventory, or identities).

82. The system of any one of claims 77-81, wherein the asset control node writes the asset data by creating data in an asset control compartment to be stored on the blockchain (e.g., wherein the asset control compartment is a block).

83. The system of claim 82, wherein creating the data in the asset control compartment requires payment of an asset fee that is held in a revenue pool from which a dividend is paid to shareholders (e.g., coin holders) once a dividend condition is met.

84. The system of any one of claims 77-83, comprising an assessor node comprising an assessor module, wherein the assessor module is for monitoring and registering asset control nodes (e.g., thereby providing the asset control nodes access to a valid asset control module).

85. The system of claim 84, wherein the assessor module requires payment of an asset control node registration fee (e.g., in a coin of the system) to register the asset control node [e.g., wherein a portion of the asset control node registration fee is held in reserve (e.g., escrow) as a form of collateral to be used in an event of bad behavior by the asset control node].

86. The system of claim 85, wherein a portion of the asset control node registration fee is held in a revenue pool from which a dividend is paid to shareholders (e.g., coin holders) once a dividend condition is met.

87. The system of any one of claims 84-86, comprising a super node comprising a super node module, wherein the super node module is for monitoring and registering assessor nodes.

88. The system of claim 87, wherein the super node is determined by a vote of shareholders (e.g., coin holders).

89. The system of any one of claims 77-88, comprising one or more transaction nodes [e.g., in the network of nodes (e.g., wherein the one or more transaction nodes are each a registered node)], each transaction node of the one or more transaction nodes comprising a transaction module, wherein the transaction module is for writing (e.g., creating) transaction data to be stored on the blockchain, wherein the transaction data corresponds to one or more transactions and/or authorizations of access (e.g., of and/or to the asset).

90. The system of claim 89, wherein the asset control module is also for registering the one or more transaction nodes (e.g., thereby providing the one or more transaction nodes access to a valid transaction module).

91. The system of claim 89 or claim 90, wherein at least one of the one or more transaction nodes further comprises a second transaction module for writing (e.g., creating) second transaction data to be stored on the blockchain, wherein the second transaction data corresponds to one or more transactions of and/or authorizations of access to a second asset (e.g., such that the at least one of the one or more transaction nodes can transact in a plurality of assets comprising the asset and the second asset).

92. The system of any one of claims 89-91, wherein the asset control node requires payment of a transaction fee to the asset control node to perform a transaction (e.g., of the asset between two parties) (e.g., for a transaction node to write transaction data to be stored on the blockchain).

93. The system of any one of claims 89-92, wherein the transaction module is also for approving and/or rejecting transaction data (e.g., over the network) (e.g., by validating the transaction data) corresponding to one or more transactions of and/or authorizations of access to the asset.

94. The system of any one of claims 77-93, comprising one or more standard nodes, wherein each standard node of the one or more standard nodes comprises a standard node module and the standard node module is for reading, verifying, and mining blocks (e.g., asset control compartments) on the blockchain.

95. The system of claim 94, wherein successfully mining the blocks on the blockchain produces a reward (e.g., an amount of coin).

96. The system of claim 95, wherein a portion of the reward is held in a revenue pool from which a dividend is paid to shareholders (e.g., coin holders) once a dividend condition is met.

97. The system of claim 94 or claim 95, wherein the reward is time-dependent (e.g., in accordance with the three method claims given above).

98. The system of any one of claims 77-97, wherein at least one of the standard nodes is one or more of the asset control node, a (e.g., the) assessor node, a (e.g., the) super node, one of (e.g., the) one or more transaction nodes.

99. A method of recording data on a blockchain used in a system comprising a plurality of nodes, the method comprising:
receiving, by a processor of a first standard node, asset data [e.g., corresponding to one or more assets (e.g., currency, inventory, or identities)] that has been written by an asset control node (e.g., wherein the asset data comprises a digital signature of the asset control node);
creating, by the processor of the first computing device, an asset control compartment comprising the asset data;
determining, by the processor of the first standard node, an asset control validation string based, at least in part, on the asset data;
modifying, by the processor of the first standard node, the asset control compartment such that the asset control compartment comprises the asset control validation string; and
optionally, storing, by the processor of the first standard node, the asset control compartment (e.g., in order to broadcast the asset control compartment to one or more of the plurality of nodes).

100. The method of claim 99, comprising:
receiving, by a processor of a second standard node, the asset control compartment, wherein the asset control compartment comprises the asset control validation string;
creating, by the processor of the second standard node, a new outer block comprising the asset control compartment;
receiving, by the processor of the second standard node, transaction data [e.g., corresponding to one or more transactions and/or authorizations of access (e.g., of and/or to the one or more assets, respectively)] that has been written by at least one transaction node (e.g., wherein the transaction data comprises a digital signature of the at least one transaction node);
creating, by the processor of the second standard node, a transaction compartment such that the transaction compartment comprises the transaction data;
modifying, by the processor of the second standard node, the new outer block such that the new outer block comprises the transaction compartment and the asset control compartment, wherein the asset control compartment comprises the asset control validation string;
determining, by the processor of the second standard node, a hash based, at least in part, on the transaction compartment and the asset control compartment; and
optionally, storing, by the processor of the second standard node, the new outer block (e.g., in order to broadcast the new outer block to one or more of the plurality of nodes).

101. The method of claim 99, comprising:
receiving, by a processor of a second standard node, transaction data [e.g., corresponding to one or more transactions and/or authorizations of access (e.g., of and/or to the one or more assets, respectively)] that has been written by at least one transaction node (e.g., wherein the transaction data comprises a digital signature of the at least one transaction node);
creating, by the processor of the second standard node, a transaction compartment such that the transaction compartment comprises the transaction data;
creating, by the processor of the second standard node, a new outer block comprising the transaction compartment;
determining, by the processor of the second standard node, a hash based, at least in part, on the transaction compartment; and
optionally, storing, by the processor of the second standard node, the new outer block (e.g., in order to broadcast the new outer block to one or more of the plurality of nodes).

102. The method of claim 101, wherein the new outer block does not comprise an asset control compartment.

103. The method of any one of claims 100-102, wherein the transaction data corresponds to a transaction of an asset that corresponds to the asset data.

104. The method of any one of claims 100-103, comprising:
determining, by the processor of the second standard node, the hash based, at least in part, on a digital signature corresponding to the second standard node.

105. The method of any one of claims 99-104, wherein the asset data is identification data corresponding to one or more personal identities.

106. The method of any one of claims 100-105, wherein the transaction data corresponds to one or more authorizations to access, records of access, or verifications of (e.g., the) identification data.

107. The method of any one of claims 100-106, wherein the transaction data corresponds to at least one of (i) one or more exchanges of at least one asset (e.g., a currency or inventory) and (ii) an authorization to access at least one asset (e.g., an identification) (e.g., wherein the asset is one of the one or more assets corresponding to the asset data).

108. The method of any one of claims 99-107, wherein the asset data corresponds to at least one of creation, update (e.g., modification), regulation, and deletion of one or more assets (e.g., currency, inventory, or identities).

109. The method of claim any one of claims 100-108, wherein the first standard node is the second standard node.

110. The method of any one of claims 99-109, wherein the blockchain is a public blockchain.

111. A system for recording data on a blockchain used in a system comprising a plurality of nodes, the system comprising:
a first processor (e.g., wherein a first standard node comprises the processor); and
a first non-transitory computer readable medium (e.g., memory) having first instructions stored thereon, wherein the first instructions, when executed by the processor, cause the processor to:
receive asset data [e.g., corresponding to one or more assets (e.g., currency, inventory, or identities)] that has been written by an asset control node (e.g., wherein the asset data comprises a digital signature of the asset control node);
create an asset control compartment comprising the asset data;
determine an asset control validation string based, at least in part, on the asset data;
modify the asset control compartment such that the asset control compartment comprises the asset control validation string; and
optionally, store the asset control compartment (e.g., in order to broadcast the asset control compartment to one or more of the plurality of nodes).

112. The system of claim 111, comprising:
a second processor (e.g., wherein a second standard node comprises the processor); and
a second non-transitory computer readable medium (e.g., memory) having second instructions stored thereon, wherein the second instructions, when executed by the second processor, cause the second processor to:
receive the asset control compartment, wherein the asset control compartment comprises the asset control validation string;
create a new outer block comprising the asset control compartment;
receive transaction data [e.g., corresponding to one or more transactions and/or authorizations of access (e.g., of and/or to the one or more assets, respectively)] that has been written by at least one transaction node (e.g., wherein the transaction data comprises a digital signature of the at least one transaction node);
create a transaction compartment such that the transaction compartment comprises the transaction data;
modify the new outer block such that the new outer block comprises the transaction compartment and the asset control compartment, wherein the asset control compartment comprises the asset control validation string;
determine a hash based, at least in part, on the transaction compartment and the asset control compartment; and
optionally, store the new outer block (e.g., in order to broadcast the new outer block to one or more of the plurality of nodes).

113. The system of claim 111, comprising:
a second processor (e.g., wherein a second standard node comprises the processor); and
a second non-transitory computer readable medium (e.g., memory) having second instructions stored thereon, wherein the second instructions, when executed by the second processor, cause the second processor to:
receive transaction data [e.g., corresponding to one or more transactions and/or authorizations of access (e.g., of and/or to the one or more assets, respectively)] that has been written by at least one transaction node (e.g., wherein the transaction data comprises a digital signature of the at least one transaction node);
create a transaction compartment such that the transaction compartment comprises the transaction data;
create a new outer block comprising the transaction compartment;
determine a hash based, at least in part, on the transaction compartment; and
optionally, store the new outer block (e.g., in order to broadcast the new outer block to one or more of the plurality of nodes).

114. The system of claim 113, wherein the new outer block does not comprise an asset control compartment.

115. The system of any one of claims 112-114, wherein the transaction data corresponds to a transaction of an asset that corresponds to the asset data.

116. The system of any one of claims 112-115, wherein the second instructions, when executed by the second processor, cause the second processor to:
determine the hash based, at least in part, on a digital signature corresponding to the second processor (e.g., the second standard node).

117. The system of any one of claims 111-116, wherein the asset data is identification data corresponding to one or more personal identities.

118. The system of any one of claims 111-117, wherein the transaction data corresponds to one or more authorizations to access, records of access, or verifications of (e.g., the) identification data.

119. The system of any one of claims 112-118, wherein the transaction data corresponds to at least one of (i) one or more exchanges of at least one asset (e.g., a currency or inventory) and (ii) an authorization to access at least one asset (e.g., an identification) (e.g., wherein the asset is one of the one or more assets corresponding to the asset data).

120. The system of any one of claims 111-119, wherein the asset data corresponds to at least one of creation, update (e.g., modification), regulation, and deletion of one or more assets (e.g., currency, inventory, or identities).

121. The system of claim any one of claims 112-120, wherein the second processor is the first processor and the second non-transitory computer readable medium is the first non-transitory computer readable medium.

122. The system of any one of claims 111-121, wherein the blockchain is a public blockchain.
